(19) United States
(12) Patent Application Publication
(10) Pub. No.: US 2013/0289210 A1
(43) Pub. Date: Oct. 31, 2013

(54) PRESSURE-SENSITIVE ADHESIVE COMPOSITION AND PRESSURE-SENSITIVE ADHESIVE SHEET

(71) Applicant: NITTO DENKO CORPORATION, Osaka (JP)

(72) Inventors: Kaori MIKI, Osaka (JP); Masato FUJITA, Osaka (JP); Takahiro NONAKA, Osaka (JP); Masahito NIWA, Osaka (JP)

(73) Assignee: NITTO DENKO CORPORATION, Osaka (JP)

(21) Appl. No.: 13/870,240

(22) Filed: Apr. 25, 2013

(30) Foreign Application Priority Data
Apr. 27, 2012 (JP) 2012-103117
Jun. 4, 2012 (JP) 2012-126915
Nov. 26, 2012 (JP) 2012-257276

(51) Int. Cl. C09J 139/06

(52) U.S. Cl. CPC C09J 139/06
USPC 525/103

(57) ABSTRACT

A pressure-sensitive adhesive composition, including an acrylic polymer produced by polymerizing a monomer component or a partial polymerization product of the monomer component. The monomer component includes alkyl (meth)acrylate having an alkyl group having 10 to 13 carbon atoms and a polar group-containing monomer other than a carboxyl group-containing monomer. A content of the alkyl (meth)acrylate is 40 wt % or more and less than 80 wt % with respect to a total amount (100 wt %) of the monomer component. A content of the polar group-containing monomer is 7 wt % or more with respect to the total amount of the monomer component. A total content of the polar group-containing monomer and an alicyclic monomer is 15 wt % or more with respect to the total amount of the monomer component.

### BACKGROUND OF THE INVENTION

1. Technical Field

The present invention relates to a pressure-sensitive adhesive composition. In addition, the present invention relates to a pressure-sensitive adhesive sheet having the pressure-sensitive adhesive layer formed from the pressure-sensitive adhesive composition.

2. Background Art

Recently, in various fields, display devices such as a liquid crystal display (LCD), or input devices which are used in combination with the display devices, such as touch panels, have been widely used. In the production or the like of those display devices or input devices, transparent pressure-sensitive adhesive sheets have been used for the purpose of laminating optical members. For instance, transparent pressure-sensitive adhesive sheets have been used for laminating touch panels, lenses or the like to display devices (such as LCDs) (see e.g. Patent Documents 1 to 3).
Patent Document 1: JP-A-2003-238915
Patent Document 2: JP-A-2003-342542
Patent Document 3: JP-A-2004-231723

### SUMMARY OF THE INVENTION

The pressure-sensitive adhesive sheet to be used for the above use has been required to be excellent in the property of being able to exhibit the pressure-sensitive adhesive force (pressure-sensitive adhesive property) even at −30° C., in order for members laminated by the pressure-sensitive adhesive sheet not to peel away during the use at not only about room temperature (23° C.) but also even a low temperature on the order of −30° C. In addition, recently, there has been a growing need for removal (rework) (especially removal at a low temperature) in the case where the optical members are bonded together, and then, they are required to be bonded again or the like. In particular, there have been growing needs for pressure-sensitive adhesive sheets which have excellent adhesiveness even at a temperature on the order of −30° C. and can be removed at a temperature less than −30° C., such as a temperature on the order of −50° C. or less.

However, conventional pressure-sensitive adhesive sheets capable of being removed are excellent in pressure-sensitive adhesive properties at about room temperature (23° C.), but there have been cases where the pressure-sensitive adhesive properties thereof have been reduced at a temperature on the order of −30° C. and the conventional pressure-sensitive adhesive sheets have been separated from adherends. More specifically, it is the status quo that pressure-sensitive adhesive sheets, which have excellent pressure-sensitive adhesive properties in a wide temperature range of about −30° C. to room temperature (23° C.) and can be removed (having reworkability) at a low temperature on the order of −50° C. or less, are still unknown.

Additionally, the pressure-sensitive adhesive properties in a wide temperature range of −30° C. to room temperature (23° C.) and the reworkability at a temperature on the order of −50° C. or less are required in not only the use for lamination of optical members but also various uses.

An object of the present invention is therefore to provide a pressure-sensitive adhesive composition which can form a pressure-sensitive adhesive layer which is excellent in the pressure-sensitive adhesive properties in a temperature range of about −30° C. to room temperature (23° C.) and has the reworkability at a temperature on the order of −50° C. or less.

As a result of our extensive studies, the present inventors have found that a pressure-sensitive adhesive sheet including a pressure-sensitive adhesive layer formed from a pressure-sensitive adhesive composition containing an acrylic polymer produced by polymerizing a monomer component including specific monomers in specific proportions or partial polymerization product thereof is excellent in the pressure-sensitive adhesive properties in a temperature range of about −30° C. to room temperature (23° C.) and has the reworkability at a temperature on the order of −50° C. or less, thereby completing the present invention.

That is, the present invention provides a pressure-sensitive adhesive composition, comprising an acrylic polymer produced by polymerizing a monomer component or a partial polymerization product of the monomer component, wherein

the monomer component include alkyl (meth)acrylate having an alkyl group having 10 to 13 carbon atoms and a polar group-containing monomer other than a carboxyl group-containing monomer,

a content of the alkyl (meth)acrylate is 40 wt % or more and less than 80 wt % with respect to a total amount (100 wt %) of the monomer component,

a content of the polar group-containing monomer is 7 wt % or more with respect to the total amount (100 wt %) of the monomer component, and

a total content of the polar group-containing monomer and an alicyclic monomer is 15 wt % or more with respect to the total amount (100 wt %) of the monomer component.

The polar group-containing monomer is preferably at least one monomer selected from the group consisting of a hydroxyl group-containing monomer and a nitrogen atom-containing monomer.

The present invention also provides a pressure-sensitive adhesive sheet, comprising a pressure-sensitive adhesive layer formed from the above pressure-sensitive adhesive composition.

A content of the acrylic polymer in the pressure-sensitive adhesive layer is preferably 50 wt % or more.

The pressure-sensitive adhesive sheet is preferably a pressure-sensitive adhesive sheet for an optical use.

The present invention also provides a double-sided pressure-sensitive adhesive sheet, wherein, in the following peel test at −30° C. using an adherend A and an adherend B, at least one of the adherend A and the adherend B is damaged; and in the following

peel test at −50° C. using the adherend A and the adherend B, the adherends A and the adherend B are peeled without damaging both of the adherend A and the adherend B, peel test at −30° C.: a test piece having a structure of adherend A/double-sided pressure-sensitive adhesive sheet/adherend B is prepared by laminating a surface of the following adherend A to one pressure-sensitive adhesive surface of a double-sided pressure-sensitive adhesive sheet having a size of 30 mm length×26 mm width, and laminating a surface of the following adherend B to the other pressure-sensitive adhesive surface of the double-sided pressure-sensitive adhesive sheet; the test piece is treated for 15 minutes under the conditions of a pressure of 5 atm and a temperature of 50° C., and then, the test piece is allowed to stand for 30 minutes under an environment of −30° C., followed by fixing the adherend A under the environment of −30° C.; and the adherend A and the adherend B are peeled by pulling the adherend B in a direction perpendicular to the surface of the adherend A;

peel test at −50° C.: a test piece having a structure of adherend A/double-sided pressure-sensitive adhesive sheet/adherend B is prepared by laminating a surface of the following adherend A to one pressure-sensitive adhesive surface of a double-sided pressure-sensitive adhesive sheet having a size of 30 mm length×26 mm width, and laminating a surface of the following adherend B to the other pressure-sensitive adhesive surface of the double-sided pressure-sensitive adhesive sheet; the test piece is treated for 15 minutes under the conditions of a pressure of 5 atm and a temperature of 50° C., and then, the test piece is allowed to stand for 30 minutes under an environment of −50° C., followed by fixing the adherend A under the environment of −50° C.; and the adherend A and the adherend B are peeled by pulling the adherend B in a direction perpendicular to the surface of the adherend A;

adherend A: a glass sheet having a thickness of 0.7 mm and a size of 100 mm length×50 mm width; and

adherend B: a slide glass having a thickness of 1.0 mm to 1.3 mm and a size of 76 mm length×26 mm width.

Because the pressure-sensitive adhesive composition o the present invention has the above constitution, the present pressure-sensitive adhesive composition can form a pressure-sensitive adhesive layer which is excellent in the pressure-sensitive adhesive properties in a temperature range of about −30° C. to room temperature (23° C.) and has the reworkability at a temperature on the order of −50° C. or less. In addition, the present pressure-sensitive adhesive sheet of the present invention which includes the pressure-sensitive adhesive layer formed from the present pressure-sensitive adhesive composition is excellent in the pressure-sensitive adhesive properties in a temperature range of about −30° C. to room temperature (23° C.) and has the reworkability at a temperature on the order of −50° C. or less.

### BRIEF DESCRIPTION OF THE DRAWINGS

FIG. 1 is a schematic diagram (plan view) showing an evaluative sample used for evaluation of glass/glass reworkability in each Example.

FIG. 2 is a schematic diagram (A-A cross-sectional view) showing an evaluative sample which is in a state of being hung with a kite string and used for evaluation of glass/glass reworkability in each Example.

FIG. 3 is a schematic diagram (cross-sectional view) showing an evaluative sample used for film T-peel test in each Example.

FIG. 4 is a schematic diagram (plan view) showing an evaluative sample used for film T-peel test in each Example.

### DETAILED DESCRIPTION OF THE INVENTION

### Pressure-Sensitive Adhesive Composition

The pressure-sensitive adhesive composition of the present invention contains an acrylic polymer produced by polymerizing a monomer component or a partial polymerization product of the monomer component. The pressure-sensitive adhesive composition may further contain a polymerization initiator, a silane coupling agent, an oligomer, a cross-linking agent, a solvent and an additive.

Examples of the pressure-sensitive adhesive composition containing a partial polymerization product of the monomer component include a so-called active energy-ray curable pressure-sensitive adhesive composition. Examples of the pressure-sensitive adhesive composition containing an acrylic polymer produced by polymerizing the monomer component include a so-called solvent type pressure-sensitive adhesive composition.

The term “partial polymerization product of the monomer component(s)” means a material obtained by partially polymerizing one or two or more of the monomer components. More specifically, examples thereof include a mixture of the monomer components with a partial polymerization product of the monomer components.

### (Acrylic Polymer)

The acrylic polymer is constituted of (formed from) the monomer component. The monomer component include alkyl (meth)acrylate having an alkyl group having 10 to 13 carbon atoms (which is referred to as “C₁₀₋₁₃ alkyl (meth)acrylate” in some cases) and a polar group-containing monomer other than a carboxyl group-containing monomer (sometimes referred simply to as “a polar group-containing monomer” hereafter). In other words, the acrylic polymer contains, as essential monomer components, C₁₀₋₁₃ alkyl (meth)acrylate and a polar group-containing monomer.

The expression “(meth)acryl” means “acryl” and/or “methacryl” (either of “acryl” or “methacryl”, or both of them), and hereafter the same meaning is given thereto. In addition, the term “alkyl group” means a straight- or branched-chain alkyl group unless otherwise specified.

The term “polar group-containing monomer” in this specification means, unless otherwise indicated, a polar group-containing monomer other than a carboxyl group—containing monomer (a monomer containing, in a molecular thereof, a polar group other than a carboxyl group).

The C₁₀₋₁₃ alkyl (meth)acrylate include is not particularly limited, and examples thereof include decyl (meth)acrylate, isodecyl (meth)acrylate, undecyl (meth)acrylate, dodecyl (meth)acrylate, tridecyl (meth)acrylate and the like. Of these (meth)acrylates, dodecyl acrylate (lauryl acrylate) is preferred. The C₁₀₋₁₃ alkyl (meth)acrylates as recited above may be used alone, or in combination of two or more thereof.

By including the polar group-containing monomer as defined above in the monomer component, since the polar group-containing monomer has moderate polarity, a pressure-sensitive adhesive layer formed from the pressure-sensitive adhesive composition can develop moderate pressure-sensitive adhesive force.

The polar group-containing monomer is not particularly limited and is preferably an ethylenically unsaturated monomer containing a polar group, and examples thereof include hydroxyl group-containing monomers such as hydroxyalkyl (meth)acrylate such as 2-hydroxyethyl (meth)acrylate, 3-hydroxypropyl (meth)acrylate, 4-hydroxybutyl (meth)acrylate and 6-hydroxyhexyl (meth)acrylate, vinyl alcohol and allyl alcohol; amide group-containing monomers such as (meth)acrylamide, N,N-dimethyl (meth) acrylamide, N-methylol (meth) acrylamide, N-methoxymethyl (meth) acrylamide, N-butoxymethyl (meth)acrylamide, N-hydroxyethyl (meth)acrylamide and N,N-dimethylaminopropyl (meth)acrylamide; amino group-containing monomers such as aminoethyl (meth)acrylate, dimethylaminoethyl (meth)acrylate and t-butylaminoethyl (meth)acrylate; epoxy group-containing monomers such as glycidyl (meth)acrylate and methylglycidyl (meth)acrylate; cyano group-containing monomers such as acrylonitrile and methacrylonitrile; hetero ring-containing vinyl monomers such as N-vinyl-2-pyrrolidone, N-vinylcaprolactam, (meth)acryloyl morpholine, N-vinylpyridine, N-vinylpiperidone, N-vinylpyrimidine, N-vinylpiperazine, N-vinylpyrrole, N-vinylimidazole, and N-vinyloxazole; sulfonic acid group-containing monomers such as sodium vinylsulfonate; phosphoric acid group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate; and the like. The polar group-containing monomer may be used either alone or in combination of two or more thereof.

The polar group-containing monomers are not particularly limited, but preferably include at least one monomer selected from the group consisting of hydroxyl group-containing monomers and nitrogen atom-containing monomers (one or more kinds of monomers selected from the group consisting of hydroxyl group-containing monomers and nitrogen atom-containing monomers) from the viewpoint of preventing the pressure-sensitive adhesive composition from excessively increasing the pressure-sensitive adhesive force with the lapse of time. Of these, from the viewpoint of developing moderate pressure-sensitive adhesive force and ensuring a moderate elastic modulus at room temperature (excellent step absorbability), it is preferred that the hydroxyl group-containing monomer and the nitrogen atom-containing monomer be both included in the polar group-containing monomers.

The nitrogen atom-containing monomer is a monomer containing at least one nitrogen atom in a molecule thereof. Examples of the nitrogen atom-containing monomer include the above amide group-containing monomers and the hetero ring-containing vinyl monomers containing a nitrogen atom of the above hetero ring-containing vinyl monomers. Of these monomers, N-vinyl-2-pyrrolidone (NVP), N-vinylcaprolactam (NVC) and N,N-dimethylacrylamide (DMAA) are preferred.

From the viewpoint of preventing the pressure-sensitive adhesive composition from excessively increasing the pressure-sensitive adhesive force with the lapse of time and increasing the pressure-sensitive adhesive force to polarizing plates, as the nitrogen atom-containing monomer, preferable examples thereof include nitrogen atom-containing monomers containing a tertiary amino group (tertiary amino group-containing monomers), and particularly preferable examples thereof include dimethylaminopropyl acrylamide (DMAPAA) and dimethylamino ethylacrylate (DMAEA).

The hydroxyl group-containing monomer is not particularly limited and preferable examples thereof include 2-hydroxyethyl acrylate.

The monomer component may further include an alicyclic monomer. In other words, the monomer component may include an alicyclic monomer as needed basis. The alicyclic monomer is an alicyclic compound excluding an aromatic compound, and is a monomer containing a non-aromatic ring in a molecule thereof. Examples of the non-aromatic ring include non-aromatic alicyclic rings (cycloalkane rings such as a cyclopentane ring, a cyclohexane ring, a cycloheptane ring and a cyclooctane ring, and cycloalkene rings such as a cyclohexene ring) and non-aromatic crosslinking rings (bicyclic hydrocarbon rings such as pinane, pinene, bornane, norbornane and norbornene, tricyclic hydrocarbon rings such as adamantane, and other crosslinking hydrocarbon rings such as tetracyclic hydrocarbon rings).

The alicyclic monomer is not particularly limited, and examples thereof include cycloalkyl (meth)acrylate such as cyclopentyl (meth)acrylate, cyclohexyl (meth)acrylate, cycloheptyl (meth)acrylate and cyclooctyl (meth)acrylate; (meth)acrylic acid esters having bicyclic hydrocarbon rings, such as bornyl (meth)acrylate, isobornyl (meth)acrylate, dicyclopentanyl (meth)acrylate and dicyclopentanyloxyethyl (meth)acrylate; and (meth)acrylic acid esters having tri- or multi-cyclic hydrocarbon rings, such as tricyclopentanyl (meth)acrylate, 1-adamantyl (meth)acrylate, 2-methyl-2-adamantyl (meth)acrylate and 2-ethyl-2-adamantyl (meth)acrylate. Of these alicyclic monomers, cyclohexyl acrylate (CHA), cyclohexyl methacrylate (CHMA), isobornyl acrylate (IBXA) and isobornyl methacrylate (IBXMA) are preferred. The alicyclic monomers as recited above may be used alone or in combination of two or more thereof.

From the viewpoint of developing moderate pressure-sensitive adhesive force at room temperature and ensuring excellent reworkability at a temperature on the order of −50° C. or less, it is preferable that the monomer component include the polar group-containing monomer and the alicyclic monomer.

In the case where an adherend contain a metal or metal oxide (e.g. a transparent conductive coating of a transparent conductive film such as an ITO film), it is preferred that carboxyl group-containing monomers are not substantially contained from standpoints that the adherend hardly suffer from corrosion, the property of filling up a step difference, such as a printing step difference, at room temperature (step absorbability) can be further enhanced and an increase of the pressure-sensitive adhesive force with the lapse of time is hard to cause. The expression “not substantially contained” means that active incorporation is not carried out, except unavoidable incorporation. More specifically, the content of the carboxyl group-containing monomers in the monomer component is preferably less than 0.05 wt %, more preferably less than 0.01 wt %, further more preferably less than 0.001 wt %, with respect to the total amount (100 wt %) of the monomer component. Examples of the carboxyl group-containing monomer include acrylic acid (AA), methacrylic acid, itaconic acid, maleic acid, fumaric acid and crotonic acid. Additionally, acid anhydrides of these carboxyl group-containing monomers (e.g. acid anhydride-containing monomers, such as maleic anhydride and itaconic anhydride) are also included in the carboxyl group-containing monomers.

The monomer component may further include a polyphunctional monomer. The polyfunctional monomer is not particularly limited, and examples thereof include hexanediol di(meth)acrylate (e.g. 1,6-hexanediol di(meth)acrylate), butanediol di(meth)acrylate, (poly)ethylene glycol di(meth)acrylate, (poly)propylene glycol di(meth)acrylate, neopentyl glycol di(meth)acrylate, pentaerythritol di(meth)acrylate (tetramethylolmethane tri(meth)acrylate), pentaerythritol tri(meth)acrylate, dipentaerythritol hexa(meth)acrylate, trimethylolpropane tri(meth)acrylate, allyl (meth)acrylate, vinyl (meth)acrylate, divinylbenzene, epoxyacrylate, polyester acrylate and urethane acrylate. Among these, 1,6-hexanediol di(meth)acrylate (HDDA) and dipentaerytbritol hexaacrylate (DPHA) are preferred. The polyfunctional monomer may be used alone or in combination of two or more thereof.

The monomer component may further include monomers (other monomers) other than the C₁₀₋₁₃ alkyl (meth)acrylate, the polar group-containing monomer, the alicyclic monomer and the polyfunctional monomer.

Examples of other monomers include (meth)acrylic acid ester having aromatic hydrocarbyl groups, such as phenyl (meth)acrylate, phenoxyethyl (meth)acrylate and benzyl (meth)acrylate; alkoxyalkyl (meth)acrylate-based monomer, such as methoxyethyl (meth)acrylate and ethoxyethyl (meth)acrylate; and alkyl (meth)acrylate having an alkyl group having 1 to 9 carbon atoms (referred to as “C₁₋₉ alkyl (meth)acrylate in some cases) and alkyl (meth)acrylate having an alkyl group having 14 to 24 carbon atoms (referred to as “C₁₄₋₂₄ alkyl (meth)acrylate in some cases). Further examples thereof include vinyl esters such as vinyl acetate and vinyl propionate; aromatic vinyl compounds such as styrene and vinyl toluene; olefins or dienes, such as ethylene, butadiene, isoprene and isobutylene; vinyl ethers such as vinyl alkyl ethers; and vinyl chloride. The other monomers as recited above can be used alone or in combination of two or more thereof.

The C₁₋₉ alkyl (meth)acrylate is not particularly limited, and examples thereof include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate and isononyl (meth)acrylate.

The C₁₄₋₂₄ alkyl (meth)acrylate is not particularly limited, and examples thereof include tetradecyl (meth)acrylate, pentadecyl (meth)acrylate, isopentadecyl (meth)acrylate, hexadecyl (meth)acrylate, isohexadecyl (meth)acrylate, heptadecyl (meth)acrylate, isoheptadecyl (meth)acrylate, octadecyl (meth)acrylate, isooctadecyl (meth)acrylate, docosyl (meth)acrylate, isodocosyl (meth)acrylate, tetracosyl (meth)acrylate and isotetracosyl (meth)acrylate.

The content of the C₁₀₋₁₃ alkyl (meth)acrylate in the monomer component is 40 wt % or more and less than 80 wt %, preferably from 45% to 78 wt %, further preferably from 50% to 76 wt %, with respect to the total amount (100 wt %) of the monomer component. By controlling the content of the C₁₀₋₁₃ alkyl (meth)acrylate to 40 wt % or more and less than 80 wt %, the pressure-sensitive adhesive layer containing the resulting acrylic polymer can have excellent pressure-sensitive adhesive property even at a low temperature on the order of −30° C. In addition, in such a layer, the pressure-sensitive adhesive force can be reduced at a temperature on the order of −50° C. or less, thereby allowing the removal thereof.

When the C₁₋₉ alkyl (meth)acrylate is included in the monomer component, the content thereof is not particularly limited, but is preferably e.g. more than 0 wt % and 40 wt % or less, more preferably from 5% to 30 wt %, further preferably from 10% to 20 wt %, with respect to the total amount (100 wt %) of monomer component. By controlling the content of the C₁₋₉ alkyl (meth)acrylate to 40 wt % or less, the pressure-sensitive adhesive layer containing the resulting acrylic polymer can have a more moderate elastic modulus and develop higher pressure-sensitive adhesive force at an ordinary temperature (on the order of 23° C.).

The total content of the polar group-containing monomers and the alicyclic monomers in the monomer component is 15 wt % or more (e.g. from 15% to 50 wt %), preferably from 18% to 40 wt %, more preferably from 20% to 30 wt %, with respect to the total amount (100 wt %) of the monomer component. By adjusting the total content thereof to 15 wt % or more, the pressure-sensitive adhesive layer containing the resulting acrylic polymer can have still more excellent pressure-sensitive adhesive property at a low temperature on the order of −30° C., and the pressure-sensitive adhesive force is more easily decreased at a temperatures on the order of −50° C. or less, thereby allowing the removal thereof more easily.

The total content of the polar group-containing monomers and the alicylic monomers means the content of the polar group-containing monomer when only the polar group-containing monomer is included, while it means the total content of the polar group-containing monomer and the alicyclic monomer when both of the polar group-containing monomer and the alicyclic monomer are included.

The content of the polar group-containing monomer in the monomer component is 7 wt % or more (e.g. from 7% to 30 wt %), preferably from 8% to 25 wt %, more preferably from 10% to 20 wt %. By adjusting the content to fall within the range of 7% to 30 wt %, still more excellent pressure-sensitive adhesive properties can be achieved in a temperature range of about −30° C. to room temperature. In addition, there may be cases where the pressure-sensitive adhesive layer containing the resulting acrylic polymer can inhibit excessive increase of the pressure-sensitive adhesive force with the lapse of time. It is preferable that the total content of the hydroxyl group-containing monomer and the nitrogen atom-containing monomer in the monomer component falls within the range specified above.

When the tertiary amino group-containing monomer as recited above is included as the polar group-containing monomers, the content thereof is not particularly limited, but is preferably more than 0 wt % and 10 wt % or less, more preferably more than 0 wt % and 5 wt % or less, further preferably more than 0 wt % and 3 wt % or less, with respect to the total amount (100 wt %) of the monomer component. By controlling the content to 10 wt % or less, the resulting pressure-sensitive adhesive layer becomes resistant to yellowing.

The proportion of the tertiary amino group-containing monomer to the polar group-containing monomers is not particularly limited, but is preferably more than 0 wt % and 20 wt % or less, more preferably more than 0 wt % and 18 wt % or less, further preferably more than 0 wt % and 16 wt % or less, with respect to the total amount (100 wt %) of the polar group-containing monomers. When the tertiary amino group-containing monomer is included in the polar group-containing monomers, the pressure-sensitive adhesive force to polarizing plates can be increased.

The content of the polar group-containing monomers in the monomer component may also be from 15% to 30 wt % (preferably 20% to 30 wt %) with respect to the total amount (100 wt %) of the monomer component. When the content of the polar group-containing monomer is within such a range with respect to the total amount (100 wt %) of the monomer component, the resulting pressure-sensitive adhesive may have still more excellent pressure-sensitive adhesive properties in a temperature range of about −30° C. to room temperature and can inhibit the excessive increase of the pressure-sensitive adhesive force with the lapse of time, and hydrophilic properties of the resulting pressure-sensitive adhesive may be enhanced to result in improvement of white-turbidity resistance under humidified conditions and the elastic modulus thereof may be heightened, thereby achieving excellent workability.

When alicyclic monomers are included in the monomer component, the content thereof is not particularly limited, but is preferably more than 0 wt % and 43 wt % or less, more preferably from 5% to 35 wt %, further preferably from 8% to 30 wt %, particularly preferably from 10% to 20 wt %, with respect to the total amount (100 wt %) of the monomer component. By controlling the content of the alicyclic monomer to 43 wt % or less, the pressure-sensitive adhesive layer containing the resulting acrylic polymer can have a still more moderate elastic modulus and develop still higher pressure-sensitive adhesive force at an ordinary temperature (on the order of 23° C.).

When the polyfunctional monomer as recited above is included in the monomer component, the content thereof is not particularly limited, but is preferably more than 0 wt % and 1 wt % or less, more preferably from 0.001% to 0.1 wt %, further preferably from 0.01% to 0.08 wt %, with respect to the total amount (100 wt %) of the monomer component. It is preferable that the content of the polyfunctional monomer is controlled to 1 wt % or less because an excessive increase of a gel fraction of the acrylic polymer produced by polymerizing such monomer components can be inhibited and the step absorbability of the pressure-sensitive adhesive layer containing the acrylic polymer becomes easy to improve. When a crosslinking agent is used, the polyfunctional monomer may not be used, but when a crosslinking agent is not used, it is preferable to use the polyfunctional monomer in the content range specified above.

Among them, when the content of the polar group-containing monomer in the monomer component is from 15% to 30 wt % (preferably from 20% to 30 wt %) with respect to the total amount (100 wt %) of the monomer component and the content of the alicyclic monomer in the monomer component is more than 0 wt % and 10 wt % or less with respect to the total amount (100 wt %) of the monomer component, the hydrophilic properties of the resulting pressure-sensitive adhesive can be enhanced to thereby improve white-turbidity resistance under humidified conditions, and can have a high elastic modulus to thereby achieve excellent workability.

In other words, the acrylic polymer produced by polymerizing the monomer component contains at least a structural unit derived from the C₁₀₋₁₃ alkyl (meth)acrylate and a structural unit derived from the polar group-containing monomer other than the carboxyl group-containing monomer. The acrylic polymer produced by polymerizing the monomer component may further contain a structural unit derived from the alicyclic monomer, a structural unit derived from the polyfunctional monomer and a structural unit derived from the other monomer. In addition, it is preferred that the acrylic polymer does not substantially contain a structural units derived from the carboxyl group-containing monomer. Each of those structural units may contain one kind of a structural unit, or two or more kinds of structural units.

The content of structural units derived from the C₁₀₋₁₃ alkyl (meth)acrylate in the acrylic polymer produced by polymerizing the monomer component (100 wt %) is 40 wt % or more and less than 80 wt %, preferably from 45% to 78 wt %, more preferably from 50% to 76 wt %.

The total content of structural units derived from the polar group-containing monomers and structural units derived from the alicyclic monomers is 15 wt % or more (e.g. from 15% to 50 wt %), preferably from 18% to 40 wt %, more preferably from 20% to 30 wt %.

The content of structural units derived from the polar group-containing monomers is 7 wt % or more (e.g. from 7% to 30 wt %), preferably from 8% to 25 wt %, more preferably from 10% to 20 wt %. The content of structural units derived from the polar group-containing monomers may be in a range of 15% to 30 wt % (further preferably 20% to 30 wt %).

When structural units derived from the alicyclic monomers are included, the content thereof is not particularly limited, but is preferably more than 0 wt % and 43 wt % or less, more preferably from 5% to 35 wt %, further preferably from 8% to 30 wt %, particularly preferably from 10% to 20 wt %.

When structural units derived from the polyfunctional monomers are included, the content thereof is not particularly limited, but is preferably more than 0 wt % and 1 wt % or less, more preferably from 0.001% to 0.1 wt %, further preferably from 0.01% to 0.08 wt %.

The content of the structural units derived from the polar group-containing monomers may be from 15% to 30 wt % (preferably from 20% to 30 wt %), and the content of the structural units derived from the alicyclic monomers may be more than 0 wt % and 10 wt % or less. The structural units derived from the alicyclic monomers may not be contained so long as the content of the structural units derived from polar group-containing monomers is from 15% to 30 wt % (further preferably from 20% to 28 wt %).

The C₁₀₋₁₃ alkyl (meth)acrylate is supposed to have a crystal-fusion temperature on the order of −60° C. to 20° C., and the side chain thereof has crystallizing properties (side-chain crystallinity) at a temperature on the order of −60° C. to 20° C. As a result, acrylic polymers formed from the C₁₀₋₁₃ alkyl (meth)acrylate have the pressure-sensitive adhesive properties at an ordinary temperature, and the elastic modulus thereof become high at temperatures on the order of −30° C., and the pressure-sensitive adhesive force is decreased thereby to occur the separation easily, whereby the acrylic polymers have reworkability.

It is thought that, by including the C₁₀₋₁₃ alkyl (meth)acrylate, the polar group-containing monomer with the content falling within the above range, the alicylic monomer with the content such that the total content of the polar group-containing monomer and alicylic monomer falls within the above range, in the monomer component forming the acrylic polymer, the side chain of the C₁₀₋₁₃ alkyl (meth)acrylate is hard to be crystallized in a wide range of about −30° C. to ordinary temperatures, and thereby the crystal-fusion temperature is shifted to a lower temperature. As a result, the acrylic polymer can have still more excellent pressure-sensitive adhesive properties in a temperature range of about −30° C. to room temperature (23° C.). At a low temperature on the order of −50° C., the side chain of the C₁₀₋₁₃ alkyl (meth)acrylate is crystallized, and thus, the acrylic polymer comes to have a high elastic modulus, and the pressure-sensitive adhesive force thereof is decreased thereby to occur the separation easily, and the reworkability is improved.

Thus, the pressure-sensitive adhesive layer formed from a pressure-sensitive adhesive composition containing the acrylic polymer produced by polymerizing the monomer component or a partial polymerization product of the monomer component has excellent pressure-sensitive adhesive properties in a temperature range of about −30° C. to an ordinary temperature, and the pressure-sensitive adhesive force thereof is easily decreased thereby to occur the separation easily at a low temperature on the order of −50° C., and thus, the excellent reworkability at a low temperature on the order of −50° C. is achieved.

Although the use of monomer components including C₁₀₋₁₃ alkyl (meth)acrylate as the essential component is mentioned in the foregoing embodiments, the scope of the present invention should not be construed as being limited to these embodiments. For example, there are cases where effects similar to the above effects can be also achieved by appropriately using the C₁₋₉ alkyl (meth)acrylate and the C₁₄₋₂₄ alkyl (meth)acrylate in combination, instead of using the C₁₀₋₁₃ alkyl (meth)acrylate. Examples of the C_{1-9 alkyl (meth)acrylate and the C}₁₄₋₂₄ alkyl (meth)acrylate include those recited hereinbefore.

The acrylic polymer obtained by polymerizing the monomer component can be prepared by polymerizing, e.g., the monomer component as mentioned above or a partial polymerization product of the monomer component (e.g. a mixture of the monomer component with a partial polymerization product of the monomer component) in accordance with conventional polymerization methods. Examples of a method for polymerizing the monomer component include a solution polymerization method, an emulsion polymerization method, a bulk polymerization method, and polymerization methods by an active energy-ray irradiation (e.g. a thermal polymerization method and an active energy-ray polymerization method). Of these methods, a solution polymerization method and an active energy-ray polymerization method are preferable in terms of transparency, water resistance, costs and so on. Although the monomer component and the partial polymerization product of the monomer component are not particularly limited, it is preferred that the polymerization be performed so as to avoid contact with oxygen (e.g. in an atmosphere of nitrogen).

As the active energy-ray irradiated in the active energy-ray polymerization (photopolymerization), examples thereof include an alpha ray, a beta ray, a gamma ray, a neutron ray, an ionizing radiation such as an electron ray, and UV, and UV is preferable. An irradiation energy, an irradiation time and an irradiation method of the active energy-ray are not particularly limited so long as the monomer component may be reacted by activating a photopolymerization initiator.

In the solution polymerization, various kinds of general solvents can be used. Examples of such a solvent include organic solvents such as: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more thereof.

When the monomer component is polymerized, a polymerization initiator such as a photopolymerization initiator (photoinitiator) or a thermal polymerization initiator may be used depending on the kind of polymerization reaction. The polymerization initiator may be used alone or in combination of two or more thereof.

The photopolymerization initiator is not particularly limited, and examples thereof include a benzoin ether photopolymerization initiator, an acetophenon photopolymerization initiator, an α-ketol photopolymerization initiator, an aromatic sulfonyl chloride photopolymerization initiator, a photoactive oxime photopolymerization initiator, a benzoin photopolymerization initiator, a benzyl photopolymerization initiator, a benzophenon photopolymerization initiator, a ketal photopolymerization initiator and a thioxantone photopolymerization initiator. The content of the photopolymerization initiator used is not particularly limited, but is preferably 0.01 to 1 parts by weight, and more preferably 0.05 to 0.5 parts by weight with respect to the total amount (100 parts by weight) of the monomer component.

As the benzoin ether photopolymerization initiator, examples thereof include benzoin methyl ether, benzoin ethyl ether, benzoin propyl ether, benzoin isopropyl ether, benzoin isobutyl ether, and 2,2-dimethoxy-1,2-diphenylethane-1-on. As the acetophenon photopolymerization initiator, examples thereof include 2,2-diethoxyacetophenon, 2,2-dimethoxy-2-phenylacetophenon, 1-hydroxycyclohexylphenylketone (α-hydroxycyclohexyl phenyl ketone), 4-phenoxydichloroacetophenon and 4-(t-butyl)dichloroacetophenon. As the α-ketol photopolymerization initiator, examples thereof include 2-methyl-2-hydroxypropiophenon and 1-[4-(2-hydroxyethyl)phenyl]-2-methylpropane-1-on. As the aromatic sulfonyl chloride photopolymerization initiator, examples thereof include 2-naphthalenesulfonyl chloride. As the photoactive oxime photopolymerization initiator, examples thereof include 1-phenyl-1,1-propanedion-2-(o-ethoxycarbonyl)-oxime. As the benzoine photopolymerization initiator, examples thereof include benzoin. As the benzyl photopolymerization initiator, examples thereof include benzyl. As the benzophenon photopolymerization initiator, examples thereof include benzophenon, benzoylbenzoate, 3,3′-dimethyl-4-methoxybenzophenon and polyvinylbenzophenon. As the ketal photopolymerization initiator, examples thereof include benzyl dimethyl ketal. As the thioxantone photopolymerization initiator, examples thereof include thioxantone, 2-chlorothioxantone, 2-methylthioxantone, 2,4-dimethylthioxantone, isopropylthioxantone, 2,4-diisopropylthioxantone and dodecylthioxantone.

As the thermal polymerization initiator, examples thereof include an azo-based polymerization initiator, a peroxide-based polymerization initiator (for example, dibenzoyl peroxide and tert-butyl permaleate) and a redox-based polymerization initiator. Among the initiators, the azo-based polymerization initiator disclosed in JP-A-2002-69411 is preferable. As the azo-based polymerization initiator, examples thereof include 2,2′-azobisisobutyronitrile, 2,2′-azobis-2-methylbutyronitrile, dimethyl 2,2′-azobis(2-methylpropionate) and 4,4′-azobis-4-cyanovaleric acid. The content of the thermal polymerization initiator used is not particularly limited, and is preferably 0.05 to 0.5 parts by weight, and more preferably 0.1 to 0.3 parts by weight with regard to the total amount (100 parts by weight) of the monomer component.

The acrylic polymer is used as an essential component in the pressure-sensitive adhesive composition of the present invention.

The partial polymerization product is a partial polymerization product constituted of (formed from) the monomer component. The partial polymerization product can be made into an acrylic polymer in accordance with the polymerization method as mentioned above (e.g. active energy-ray polymerization method).

The degree of polymerization of the monomer component in the partial polymerization product is not particularly limited, but is preferably from 5% to 20 wt %, more preferably from 5% to 15 wt %, in terms of the viscosity suitable for handling and coating of the pressure-sensitive adhesive composition of the present invention.

The degree of polymerization can be determined as follows.

A portion of the partial polymerization product is taken out as a sample. The weight of the sample is determined by precise weighing and referred to as “weight of partial polymerization product before being dried”. And then the sample is dried at 130° C. for 6 hours, and the weight of the thus dried sample is determined by precise weighing and referred to as “weight of the partial polymerization product after being dried”. Then, the weight of the sample reduced in weight by drying at 130° C. for 2 hours is determined from “weight of the partial polymerization product before being dried” and “weight of the partial polymerization product after being dried”, and referred to as “weight decrement” (the total weight of volatile ingredients and unreacted monomers). The degree of polymerization (wt %) of the partial polymerization product of the monomer component is determined from the thus obtained “weight of the partial polymerization product before being dried” and “weight decrement” according to the following expression.

Degree of polymerization (wt %) of the partial polymerization product of the monomer component=[1−(weight decrement)/(weight of the partial polymerization product before being dried)]×100

The partial polymerization product may be used as an essential component, for example, in the pressure-sensitive adhesive composition of the present invention.

The pressure-sensitive adhesive composition of the present invention may include a crosslinking agent. The crosslinking agent include is not particularly limited, and examples thereof include isocyanate-based crosslinking agents, epoxy-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, oxazoline-based crosslinking agents, aziridine-based crosslinking agents and amine-based crosslinking agents. Of these crosslinking agents, isocyanate-based crosslinking agents and epoxy-based crosslinking agents are preferred. Such crosslinking agents may be used alone, or in combination of two or more thereof.

As the isocyanate-based crosslinking agent (polyfunctional isocyanate compound), examples thereof include lower aliphatic polyisocyanates such as 1,2-ethylene diisocyanate, 1,4-butylenediisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. In addition thereto, a trimethylolpropane/tolylene diisocyanate adduct (manufactured by Nippon Polyurethane Industry Co., Ltd., trade name “CORONATE L” or the like), and a trimethylolpropane/hexamethylene diisocyanate adduct (manufactured by Nippon Polyurethane Industry Co., Ltd., trade name “CORONATE HL” or the like) may also be used.

As the epoxy-based crosslinking agent (polyfunctional epoxy compound), examples thereof include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl)isocyanurate, resorcin diglycidyl ether, bisphenol-S-diglycidyl ether and an epoxy-based resin having two or more epoxy groups in the molecule. As commercially available products thereof, trade name “TETRAD C” manufactured by Mitsubishi Gas Chemical Company, Inc. may be used.

The content of the crosslinking agent is not particular limited, but is preferably from 0.001 to 10 parts by weight, preferably from 0.01 to 3 parts by weight, with respect to the total amount (100 parts by weight) of the monomer component, from the viewpoint of adjusting the gel fraction of the pressure-sensitive adhesive layer formed from the pressure-sensitive adhesive composition of the present invention to a range within a favorable range.

The pressure-sensitive adhesive composition of the present invention may include a silane coupling agent from the viewpoint of further improving the pressure-sensitive adhesive properties under the humidified environment at temperatures ranging from about −30° C. to room temperature. The silane coupling agent is not particularly limited, and examples thereof include silane coupling agents with functional groups (such as a vinyl group, an epoxy group, an amino group, a mercapto group, an acryloxy group, a methacryloxy group, an isocyanato group, a styryl group and a polysulfide group). Of these, the silane coupling agents with epoxy groups (epoxy group-containing silane coupling agents) are preferred from the viewpoint of improving the pressure-sensitive adhesive properties particularly to a glass adherend. More specifically, examples thereof include vinyl group-containing silane coupling agents, such as vinyltrimethoxysilane; epoxy group-containing silane coupling agents, such as γ-glycidoxypropyltrimethoxysilane and γ-glycidoxypropyltriethoxysilane; amino group-containing silane coupling agents, such as γ-aminopropyltrimethoxysilane and N-β(aminoethyl) γ-aminopropyltrimethoxysilane; mercapto group-containing silane coupling agents, such as γ-mercaptopropylmethyldimethoxysilane; acryloxy group-containing silane coupling agents, such as γ-acryloxypropyltrimethoxysilane; methacryloxy group-containing silane coupling agents, such as γ-methacryloxypropyltriethoxysilane; isocyanato group-containing silane coupling agents, such as 3-isocyanatopropyltriethoxysilane; styryl group-containing silane coupling agents, such as p-styryltrimethoxysilane; and polysulfide group-containing silane coupling agents, such as bis(triethoxysilylpropyl)tetrasulfide. These silane coupling agents may be used alone, or in combination of two or more thereof.

The content of the silane coupling agent is not particularly limited, but is preferably from 0.01 to 2 parts by weight, more preferably from 0.03 to 1 parts by weight, with respect to the total amount (100 parts by weight) of the monomer component.

The pressure-sensitive adhesive composition of the present invention may include an oligomer from the viewpoint of improving the pressure-sensitive adhesive properties at room temperature. The oligomer is an oligomer (polymer) different from the above-described acrylic polymer and partial polymerization products of the monomer component. The word “different” used above means that the oligomer does not completely same as the acrylic polymer and the partial polymerization products in terms of constituent monomers and their contents.

The oligomer is not particularly limited, and is preferably an oligomer containing, as essential monomer components, (meth)acrylic acid ester having a ring structure in its molecule (which is referred to as “ring-containing (meth)acrylic acid ester” in some cases) and alkyl (meth)acrylate containing a straight- or branched-chain alkyl group.

The ring-containing (meth)acrylic acid ester is not particularly limited, and examples thereof include cycloalkyl (meth)acrylate, such as cyclopentyl (meth)acrylate, cyclohexyl (meth)acrylate, cycloheptyl (meth)acrylate and cyclooctyl (meth)acrylate; (meth)acrylic acid ester having a bicyclic aliphatic hydrocarbon ring, such as isobornyl (meth)acrylate; (meth)acrylic acid ester having tri- or multi-cyclic aliphatic hydrocarbon ring, such as dicyclopentanyl (meth)acrylate, dicyclopentanyloxyethyl (meth)acrylate, tricyclopentanyl (meth)acrylate, 1-adamantyl (meth)acrylate, 2-methyl-2-adamantyl (meth)acrylate and 2-ethyl-2-adamantyl (meth)acrylate; and (meth)acrylic acid ester having an aromatic ring, such as aryl (meth)acrylate such as phenyl (meth)acrylate, aryloxyalkyl (meth)acrylate such as phenoxyethyl (meth)acrylate, and arylalkyl (meth)acrylate such as benzyl (meth)acrylate. Among them, (meth)acrylic acid ester having a tri- or multi-cyclic aliphatic hydrocarbon ring (particularly, tri- or multi-crosslinking hydrocarbon ring) is preferable from the viewpoint of making it hard to cause inhibition of polymerization, and dicyclopentanyl methacrylic acid (DCPMA) is more preferred. The ring-containing (meth) acrylic acid ester may be used either alone, or in combination of two or more thereof.

The content of the ring-containing (meth)acrylic acid ester is not particularly limited, but is preferably e.g. from 10% to 90 wt %, more preferably from 20% to 80 wt %, further preferably from 35% to 80 wt %, with respect to the total amount (100 wt %) of monomer components forming the oligomer.

The alkyl (meth)acrylate containing a straight- or branched-chain alkyl group in the oligomer is not particularly limited, and examples thereof include alkyl (meth)acrylates having an alkyl group (straight- or branched-chain alkyl group) having 1 to 20 carbon atoms, such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. Of these, methyl methacrylate (MMA) is preferred. The alkyl (meth)acrylate containing a straight- or branched-chain alkyl group may be used alone, or in combination of two or more thereof.

The content of the alkyl (meth)acrylate containing a straight- or branched-chain alkyl group in the oligomer is not particularly limited, but is preferably from 10% to 90 wt %, more preferably from 20% to 80 wt %, further preferably from 20% to 60 wt %, with respect to the total amount (100 wt %) of monomer components forming the oligomer, from the viewpoint of allowing the pressure-sensitive adhesive layer to have a moderate elastic modulus.

The monomer components forming the oiligomer is not particularly limited, and examples thereof may further include alkoxyalkyl (meth)acrylate, a carboxyl group-containing monomer, an amido group-containing monomer, an amino group-containing monomer, a cyano group-containing monomer, a sulfonic group-containing monomer, a phosphoric group-containing monomer, an isocyanato group-containing monomer, an imide group-containing monomer and the like.

The oligomer can be formed by polymerizing such monomer components forming the oligomer in accordance with a conventional polymerization method. Examples of the polymerization method for obtaining the oligomer include a solution polymerization method, an emulsion polymerization, a bulk polymerization method and polymerization methods by an active energy-ray irradiation (e.g. an active energy-ray polymerization method).

On the occasion of polymerization for forming the oligomer, various kinds of general solvents can be used. Examples thereof include organic solvents, such as esters such as ethyl acetate and n-butyl acetate, aromatic hydrocarbons such as toluene and benzene, aliphatic hydrocarbons such as n-hexane and n-heptane, alicyclic hydrocarbons such as cyclohexane and methylcyclohexane, and ketones such as methyl ethyl ketone and methyl isobutyl ketone. These solvents may be used alone, or in combination of two or more thereof.

Further, on the occasion of polymerization for forming the oligomer, a conventional polymerization initiator may be used. Examples of the polymerization initiator include: azo-based initiators such as 2,2′-azobisisobutyronitrile (AIBN), 2,2′-azobis-2-methylbutyronitrile (AMBN), dimethyl 2,2′-azobis(2-methylpropionate), 4,4′-azobis-4-cyanovalerianic acid, 2,2′-azobis(4-methoxy-2,4-dimethylvaleronitrile), 2,2′-azobis(2,4-dimethylvaleronitrile), 1,1′-azobis(cyclohexane-1-carbonitrile) and 2,2′-azobis(2,4,4-trimethylpentane); and peroxide-based initiators, such as benzoyl peroxide, t-butyl hydroperoxide, di-t-butyl peroxide, t-butyl peroxybenzoate, dicumyl peroxide, 1,1-bis(t-butylperoxy)-3,3,5-trimethyleyclohexane and 1,1-bis(t-butylperoxy)cyclododecane. In the case of the solution polymerization, an oil-soluble polymerization initiator is preferably used. Those polymerization initiators may be used alone, or in combination of two or more thereof. The used amount of the polymerization initiator is not particularly limited as long as the used amount falls within a usual range. For instance, the used amount is chosen appropriately from the range of 0.1 to 15 parts by weight with respect to the total amount (100 parts by weight) of monomer components forming the oligomer.

On the occasion of polymerization for forming the oligomer, a chain transfer agent can be used for the purpose of controlling its molecular weight. As the chain transfer agent, examples thereof include 2-mercaptoethanol, α-thioglycerol, 2,3-dimercapto-1-propanol, octyl mercaptan, t-nonyl mercaptan, dodecyl mercaptan (lauryl mercaptan), t-dodecyl mercaptan, glycidyl mercaptan, thioglycolic acid, methyl thioglycolate, ethyl thioglycolate, propyl thioglycolate, butyl thioglycolate, t-butyl thioglycolate, 2-ethylhexyl thioglycolate, octyl thioglycolate, isooctyl thioglycolate, decyl thioglycolate, dodecyl thioglycolate, thioglycolic acid ester of ethylene glycol, thioglycolic acid ester of neopentyl glycol, thioglycolic acid ester of pentaerythritol, and α-methylstyrene dimer. Among them, thioglycolic acid and α-thioglycerol are preferred. Those chain transfer agents may be used alone, or in combination of two or more thereof.

From the viewpoint of controlling the molecular weight of the oligomer to an appropriate range, the content (used amount) of the chain transfer agent is not particularly limited, but is preferably from 0.1 to 20 parts by weight, more preferably from 0.2 to 15 parts by weight, further preferably from 0.3 to 10 parts by weight, with respect to the total amount (100 parts by weight) of monomer components forming the oligomer.

The weight-average molecular weight (Mw) of the oligomer is preferably from 1,000 to 30,000, more preferably from 1,000 to 20,000, further preferably from 1,500 to 10,000, still further preferably from 2,000 to 4,000. By controlling the weight-average molecular weight of the oligomer to 1,000 or more, the pressure-sensitive adhesive force and retention properties are enhanced. By controlling the weight-average molecular weight of the oligomer to 30,000 or less, the pressure-sensitive adhesive force at room temperature is enhanced.

The weight-average molecular weight of the oligomer can be measured by gel permeation chromatography (GPC). More specifically, a measurement is performed by using e.g. a GPC measurement device, HLC-8120GPC (trade name, a product of Tosoh Corporation), under the following conditions, and then, the weight-average molecular weight of the oligomer can be calculated by standard polystyrene conversion value.

### (Measurement Conditions for Weight-Average Molecular Weight)

Sample concentration: About 2.0 g/L (tetrahydrofuran solution)

Amount of sample injected: 20 μL

Column: TSK GEL, SUPER AWM-H+SUPER AW4000+SUPER AW2500, trade names, products of Tosoh Corporation

Column size: Each 6.0 mm I.D.×150 mm

Eluent: Tetrahydrofuran (THF)

Flow rate: 0.4 mL/min

Detector: Refractive index (RI) detector

Column temperature (measurement temperature): 40° C.

The glass transition temperature (Tg) of the oligomer is not particularly limited, but is preferably from 20° C. to 300° C., more preferably from 30° C. to 300° C., further preferably from 40° C. to 300° C. By adjusting the glass transition temperature of the oligomer to 20° C. or more, there is a tendency that in the pressure-sensitive adhesive force at room temperature is improved. By controlling the glass transition temperature of the oligomer to 300° C. or less, there is a tendency that the pressure-sensitive adhesive layer can have moderate flexibility and in the pressure-sensitive adhesive force and step absorbability thereof are improved.

The glass transition temperature (Tg) of the oligomer is a glass transition temperature (theoretical value) represented by the following equation.

1/Tg=W₁/Tg₁+W₂/Tg₂+ . . . +Wₙ/Tgₙ

In the equation, Tg stands for the glass transition temperature (unit: K) of the oligomer, Tgᵢ stands for the glass transition temperature (unit: K) of a homopolymer formed from a monomer i, and Wᵢ stands for the weight fraction of the monomer i with respect to the total weight of the monomer component (i=1, 2, . . . , n). The foregoing is an expression for calculation in the case of the oligomer formed from n kinds of monomer components, namely a monomer 1, a monomer 2, . . . , and a monomer n.

The “glass transition temperature (Tg) of a homopolymer formed from a monomer” in the present invention (this may be simply referred to as “glass transition temperature (Tg) of a homopolymer”) means “glass transition temperature (Tg) of the homopolymer of the monomer”, and its concrete data are shown in “Polymer Handbook” (3rd Ed., by John Wiley & Sons, Inc., 1989). Tg of homopolymers of other monomer than those shown in the reference can be measured, for example, according to the measurement method mentioned below (see JP-A-2007-51271, which is herein incorporated by reference). Briefly, 100 parts by weight of a monomer, 0.2 parts by weight of azobisisobutyronitrile and 200 parts by weight of a polymerization solvent, ethyl acetate are put into a reactor equipped with a thermometer, a stirrer, a nitrogen-introducing duct and a reflux condenser tube, and stirred for 1 hour with introducing nitrogen gas thereinto. Oxygen is removed from the polymerization system in that manner, then this is heated up to 63° C. and reacted for 10 hours. Next, this is cooled to room temperature to give a homopolymer solution having a solid concentration of 33% by weight. Next, the homopolymer solution is cast onto a release liner and dried to prepare a test sample having a thickness of about 2 mm (sheet-like homopolymer). The test sample is blanked into a disc having a diameter of 7.9 mm, and sandwiched between parallel plates, and its viscoelasticity is measured using a viscoelasticity tester (ARES, by Rheometrics) with a shear strain of frequency 1 Hz given thereto, in a shear mode within a temperature range of from −70 to 150° C. at a heating speed of 5° C./min, and the peak top temperature at tans is regarded as Tg of the homopolymer.

The content of the oligomer in the pressure-sensitive adhesive composition of the present invention is not particularly limited, but is preferably from 1 to 10 parts by weight, more preferably from 1.5 to 8 parts by weight, further preferably from 2 to 5 parts by weight, with respect to the total amount (100 parts by weight) of the monomer component forming the acrylic polymer, from the viewpoint of enhancing the compatibility with the acrylic polymer and enhancing the pressure-sensitive adhesive force at room temperature. The amount of the acrylic polymer in the pressure-sensitive adhesive composition of the present invention is equal to the total of monomer components forming the acrylic polymer.

The pressure-sensitive adhesive composition of the present invention may include a solvent. The solvent is not particularly limited, and examples thereof include organic solvents, such as esters such as ethyl acetate and n-butyl acetate, aromatic hydrocarbons such as toluene and benzene, aliphatic hydrocarbons such as n-hexane and n-heptane, alicyclic hydrocarbons such as cyclohexane and methylcyclohexane, ketones such as methyl ethyl ketone and methyl isobutyl ketone, and alcohols such as methanol and butanol. These solvents may be used alone, or in combination of two or more thereof.

The pressure-sensitive adhesive composition of the present invention may include well-known additives (other additives) so long as the inclusion thereof does not impair the effects of the present invention, and examples thereof include a crosslinking accelerator, a tackifying resin (e.g. a rosin derivative, a polyterpene resin, a petroleum resin, oil-soluble phenol), an anti-aging agent, a filler, a coloring agent (such as pigments and dyes), a UV absorbent, an oxidation inhibitor, a chain transfer agent, a plasticizer, a softening agent, a surfactant and an antistatic agent.

The preparation method of the pressure-sensitive adhesive composition of the present invention is not particularly limited, and examples thereof include a method by mixing: the acrylic polymer produced from the monomer component or the partial polymerization product of the monomer component which is an essential component; and the monomer components, the polymerization initiator, the silane coupling agent, the oligomer, the solvent, the crosslinking agent, the additives and on the like which may be added if needed. The preparation method of the pressure-sensitive adhesive composition containing, as the essential component, the acrylic polymer obtained by polymerizing the monomer component is not particularly limited, and examples thereof include a method by solving, in a solvent: the acrylic polymer produced by polymerizing the monomer component; and the monomer component, the crosslinking agent, the silane coupling agent, the oligomer, the additive and the like which may be added if needed. The preparation method of the pressure-sensitive adhesive composition containing, as the essential component, the partial polymerization product of the monomer component is not particularly limited, and examples thereof include a method by mixing: the partial polymerization product of the monomer component; and the monomer components, the polymerization initiator, the silane coupling agent, the oligomer, the solvent, the crosslinking agent, the additives and the like which may be added if needed.

### [Pressure-Sensitive Adhesive Sheet]

The pressure-sensitive adhesive sheet of the present invention preferably has at least one pressure-sensitive adhesive layer formed from the pressure-sensitive adhesive composition of the present invention (which layer is referred to as “the pressure-sensitive adhesive layer of the present invention” in some cases). In addition to the pressure-sensitive adhesive layer of the present invention, the pressure-sensitive adhesive sheet of the present invention may have a substrate, a pressure-sensitive adhesive layer other than the pressure-sensitive adhesive layer of the present invention (the other pressure-sensitive adhesive layer) and other layers (e.g. an intermediate layer and an undercoat layer). As to each of the layers different from the pressure-sensitive adhesive layer of the present invention, only one layer thereof or two or more layers thereof may be provided. The term “pressure-sensitive adhesive sheet” is intended to include the aspect of the “pressure-sensitive adhesive tape”. In other words, the pressure-sensitive adhesive sheet of the present invention may have a tape form.

The pressure-sensitive adhesive sheet of the present invention may be a single-sided pressure-sensitive adhesive sheet which has the surface of a pressure-sensitive adhesive layer (pressure-sensitive adhesive surface) on one side alone, or it may be a double-sided pressure-sensitive adhesive sheet which has the surfaces of a pressure-sensitive adhesive layer on both sides. The pressure-sensitive adhesive sheet of the present invention is not particularly limited, but is preferably a double-sided pressure-sensitive adhesive sheet, more preferably a double-sided pressure-sensitive adhesive sheet having the surfaces of the pressure-sensitive adhesive layer of the present invention on both sides, from the viewpoint of allowing the use for laminating two adherends together.

The pressure-sensitive adhesive sheet of the present invention may be a pressure-sensitive adhesive sheet having no substrate (substrate layer), or the so-called “substrateless-type” pressure-sensitive adhesive sheet (sometimes referred to as “substrateless pressure-sensitive adhesive sheet), or it may be a pressure-sensitive adhesive sheet having a substrate. Examples of the substrateless pressure-sensitive adhesive sheet include a double-sided pressure-sensitive adhesive sheet consisting of the pressure-sensitive adhesive layers of the present invention and a double-sided pressure-sensitive adhesive sheet including the pressure-sensitive adhesive layer of the present invention and a pressure-sensitive adhesive layer other than the pressure-sensitive adhesive layer of the present invention (which is referred to as “other pressure-sensitive adhesive layer” in some cases). Examples of the pressure-sensitive adhesive sheet having a substrate include a single-sided pressure-sensitive adhesive sheet having the pressure-sensitive adhesive layer of the present invention on one side of the substrate thereof, a double-sided pressure-sensitive adhesive sheet having the pressure-sensitive adhesive layer of the present invention on both sides of the substrate thereof, and a double-sided pressure-sensitive adhesive sheet having the pressure-sensitive adhesive layer of the present invention on one side of the substrate thereof and the other pressure-sensitive adhesive layer on the other side of the substrate thereof.

Of these, from the viewpoint of improvements in optical properties such as transparency, the substrateless pressure-sensitive adhesive sheets are preferred and the double-sided substrateless pressure-sensitive adhesive sheet consisting of the pressure-sensitive adhesive layer of the present invention is more preferred. When the pressure-sensitive adhesive sheet of the present invention is a pressure-sensitive adhesive sheet having a substrate, there is no particular restriction, but the pressure-sensitive adhesive sheet of the present invention is preferably a double-sided pressure-sensitive adhesive sheet having the pressure-sensitive adhesive layer of the present invention on both sides of the substrate in terms of workability. The term “substrate (substrate layer)” used herein refers to the part laminated on an adherend together with the pressure-sensitive adhesive layer when the pressure-sensitive adhesive sheet of the present invention is applied (laminated) to the adherend (e.g. an optical member), and does not include a separator (release liner) which is peeled away when the pressure-sensitive adhesive sheet is used (lainated).

### (Substrate)

The substrate is not particularly limited, and examples thereof include plastic films and various kinds of optical films, such as an antireflection (AR) film, a polarizing plate and a retardation plate. As materials for the plastic films or the like, examples thereof include plastic materials, such as polyester resins such as polyethylene terephthalate (PET), acrylic resins such as polymethyl methacrylate, polycarbonate, triacetyl cellulose, polysulfone, polyarylate, polyimide, polyvinyl chloride, polyvinyl acetate, polyethylene, polypropylene, an ethylene-propylene copolymer, and cyclic olefin polymers such as “ARTON” (trade name, manufactured by JSR Corporation) and “ZEONOR” (trade name, manufactured by ZEON CORPORATION). These plastic materials may be used alone, or in combination of two or more thereof.

The substrate is not particularly limited, but is preferably e.g. a transparent substrate. The “transparent substrate” used herein refers to the substrate having, e.g. a total light transmittance in the visible light wavelength region of preferably 85% or more, more preferably 88% or more, as measured in accordance with JIS K 7361-1. In addition, a haze of the transparent substrate (as measured in accordance with JIS K 7136) is preferably, e.g. 1.5% or less, more preferably 1.0% or less. Examples of the transparent substrate include PET film and non-oriented films such as “ARTON” (trade name, a product of JSR Corporation) and “ZEONOR” (trade name, a product of ZEON CORPORATION).

The thickness of the substrate is not particularly limited, but is preferably from 12 to 75 μm. The substrate may have either a single-layer form or a multiple-layer form. Further, the substrate surface may be appropriately subjected to conventional surface treatment, such as physical treatment such as corona discharge treatment or plasma treatment, or chemical treatment such as undercoating treatment.

### (Pressure-Sensitive Adhesive Layer)

The pressure-sensitive adhesive layer of the present invention contains the acrylic polymer as an essential ingredient. The content of the acrylic polymer in the pressure-sensitive adhesive layer of the present invention is not particularly limited, but is preferably, e.g. 50 wt % or more, more preferably 60 wt % or more, further preferably 80 wt % or more, with respect to the total weight (100 wt %) of the pressure-sensitive adhesive layer, from the viewpoint of allowing formation of a pressure-sensitive adhesive layer still more excellent in the pressure-sensitive adhesive properties at temperatures ranging from about −30° C. to room temperature (23°) as well as reworkability at temperatures on the order of −50° C. or less, and moreover excellent in step absorbability.

The pressure-sensitive adhesive layer of the present invention is formed by subjecting a pressure-sensitive adhesive composition containing the acrylic polymer to drying, curing and so on. Alternatively, the pressure-sensitive adhesive layer of the present invention is formed via the production of acrylic polymer by subjecting the pressure-sensitive adhesive composition containing a partial polymerization product of the monomer components to curing (e.g. thermosetting or curing by irradiation with active energy rays such as UV rays).

The thickness of the pressure-sensitive adhesive layer of the present invention is not particularly limited, but is preferably from 10 μm to 1 mm, more preferably from 100 μm to 500 μm, further preferably from 150 μm to 350 μm. By adjusting the thickness to 10 μm or more, the pressure-sensitive adhesive layer formed can have excellent step absorbability. By controlling the thickness to 1 mm or less, the pressure-sensitive adhesive layer formed resists deformation, and workability thereof can be enhanced.

The gel fraction of the pressure-sensitive adhesive layer of the present invention is not particularly limited, but is preferably from 20% to 90 wt %, more preferably from 30% to 85 wt %, further preferably from 40% to 80 wt %. By controlling the gel fraction to 90 wt % or less, the pressure-sensitive adhesive layer is reduced in cohesive force to some extent, and becomes soft and tends to follow step-difference portions, thereby improving the step absorbability. On the other hand, when the gel fraction thereof is less than 20 wt %, the pressure-sensitive adhesive layer is too soft and workability of the pressure-sensitive adhesive sheet is lowered. In addition, under high-temperature environments or high-temperature high-humidity environments, air bubbles or lift-off tend to be easily occurred, and thus, anti-foaming release property is decreased. The gel fraction can be controlled by, e.g. kinds and contents (usage) of a polyfunctional monomer and/or a crosslinking agent.

The gel fraction (proportion of solvent-insoluble matter) can be determined as a matter insoluble in ethyl acetate. Specifically, the gel fraction is determined as the proportion (unit: wt %) of the weight of insoluble matter after immersion of a sample of the pressure-sensitive adhesive layer in ethyl acetate at room temperature (23° C.) for 7 days to the weight of the sample before the immersion. More specifically, the gel fraction is a value calculated according to the following “Method of measuring gel fraction”.

### (Method of Measuring Gel Fraction)

About 1 g of a portion of the pressure-sensitive adhesive layer is sampled, and the weight thereof is measured and referred to as “weight of pressure-sensitive adhesive layer before immersion”. Next, the sampled pressure-sensitive adhesive layer is immersed in 40 g of ethyl acetate for 7 days, and then, all the matter insoluble in the ethyl acetate (insoluble residues) is collected and all of the collected insoluble residues are dried at 130° C. for 2 hours to thereby remove the ethyl acetate. Thereafter, the weight thereof is measured, and referred to as “dry weight of insoluble residues” (weight of pressure-sensitive adhesive layer after immersion). Then, the gel fraction is calculated according to the following expression.

Gel fraction (wt %)=[(dry weight of insoluble residues)/(weight of pressure-sensitive adhesive layer before immersion)]×100

The weight-average molecular weight of soluble matter (sol matter) in the pressure-sensitive adhesive layer of the present invention is not particularly limited, but is preferably from 1.0×10⁵ to 5.0×10⁶, more preferably from 2.0×10⁵ to 2.0×10⁶, further preferably from 3.0×10⁵ to 1.0×10⁶. When the weight-average molecular weight of the sol matter is less than 1.0×10⁵, there may be cases where in the pressure-sensitive adhesive force is reduced. When the weight-average molecular weight of the sol matter is more than 5.0×10⁶, there may be cases where the elastic modulus thereof is increased and the pressure-sensitive adhesive force is decreased.

The “weight average molecular weight of soluble matter (sol matter)” is calculated according to the following measurement method.

### (Method of Measuring Weight-Average Molecular Weight of Soluble Matter (Sol Matter))

About 1 g of a portion of the pressure-sensitive adhesive layer is sampled, wrapped with a porous tetrafluoroethylene sheet having an average pore size of 0.2 μm, NTF1122 (trade name, a product of NITTO DENKO CORPORATION), and then tied with kite string (here, the pressure-sensitive adhesive layer in this state is referred to as “a sample”). Next, the sample is put in a 50-ml container filled with ethyl acetate and left standing for one week (7 days) at 23° C. Thereafter, the ethyl acetate solution (containing the thus extracted sol matter) in the container is taken out and the solvent (ethyl acetate) is volatilized by drying under a reduced pressure, thereby obtaining a sol matter.

The sol matter is dissolved in tetrahydrofuran (THF), and the weight-average molecular weight (Mw) thereof is determined from measurement using a GPC measurement device, HLC-8120GPC (trade name, a product of Tosoh Corporation), under the following conditions with polystyrene conversion value.

### (GPC Measurement Conditions)

Sample concentration: 0.2 wt % (tetrahydrofuran solution)

Amount of sample injected: 10 μL

Eluent: Tetrahydrofuran (THF)

Flow rate (flow velocity): 0.6 mL/min

Column temperature (measurement temperature): 40° C.

Column: TSK GEL SUPER HM-H/H4000/H3000/H200, trade names, products of Tosoh Corporation

Detector: Refractive index (RI) detector

The melting point of the pressure-sensitive adhesive layer of the present invention is not particularly limited, but is preferably from −60° C. to 0° C., more preferably from −50° C. to −10° C., further preferably from −40° C. to −15° C. or from −30° C. to −10° C. When the melting point thereof is more than 0° C., the pressure-sensitive adhesion cannot be developed in a temperature range of −30° C. to room temperature. The measurement of the melting point is not particularly limited, and the melting point can be measured by using the pressure-sensitive adhesive layer as a measurement sample according to differential scanning calorimetry (DSC) in conformity with JIS K 7121. Specifically, the measurement can be carried out e.g. by using a measurement device, Q-2000 (trade name, a product of TA Instruments, Inc.) under the condition of rate of temperature rise of 10° C./min from −80° C. to 80° C. More specifically, the melting point can be measured by the method described later in the section “Evaluations” under “(5) Melting point”.

The other pressure-sensitive adhesive layers (pressure-sensitive adhesive layers other than the pressure-sensitive adhesive layer of the present invention) is not particularly limited, and examples thereof include conventional pressure-sensitive adhesive layers formed from known pressure-sensitive adhesives, such as urethane-based pressure-sensitive adhesives, acrylic pressure-sensitive adhesives, rubber-based pressure-sensitive adhesives, silicone-based pressure-sensitive adhesives, polyester-based pressure-sensitive adhesives, polyamide-based pressure-sensitive adhesives, epoxy-based pressure-sensitive adhesives, vinyl alkyl ether-based pressure-sensitive adhesives and fluorine-based pressure-sensitive adhesives. These other pressure-sensitive adhesives may be used alone, or in combination of two or more thereof.

The pressure-sensitive adhesive layer surface (pressure-sensitive adhesive surface) of the pressure-sensitive adhesive sheet of the present invention may be protected with a separator (release liner) until it is used. In the double-sided pressure-sensitive adhesive sheet of the present invention, each pressure-sensitive adhesive surface may be protected by two separators, respectively, or protected in such a way that the surface is wound in a roll form by using one separator of which both sides are release surfaces. The separator is used as a protective material of the pressure-sensitive adhesive layer, and peeled away when the pressure-sensitive adhesive sheet of the present invention is laminated to an adherend. In addition, the separator also plays a role as the substrate of the pressure-sensitive adhesive layer. The separator may not be provided.

Any known release paper may be used as the separator. The separator is not particularly limited, and examples thereof include a substrate having a release treated layer, a low adhesive substrate composed of a fluorine polymer, or a low adhesive substrate composed of a non-polar polymer. As the substrate having the release treated layer, examples thereof include a plastic film or paper whose surface is treated with a release agent such as silicon-based release agent, long-chaine alkyl-based release agent, fluorine-based release agent, and molybdenum sulfide-based release agent. As the fluorine-based polymer, examples thereof include polytetrafluoroethylene, polychlorotrifluoroethylene, polyvinyl fluoride, polyvinylidene fluoride, a tetrafluoroethylene-hexafluoropropylene copolymer and a chlorofluoroethylene-vinylidene fluoride copolymer. As the non-polar polymer, examples thereof include an olefin-based resin (for example, polyethylene, polypropylene and the like). The separator can be formed by using a known/general method. The thickness of the separator is not particularly limited.

As a method for manufacturing the pressure-sensitive adhesive sheet of the present invention, a conventional manufacturing method can be applied. The method for manufacturing the pressure-sensitive adhesive sheet of the present invention varies depending on the composition of the pressure-sensitive adhesive of the present invention, and no particular limitation is imposed thereon. Examples thereof include the following methods (1) to (3). When the pressure-sensitive adhesive sheet of the present invention is a double-sided pressure-sensitive adhesive sheet, the methods for forming each surface of the pressure-sensitive adhesive layers may be the same as or different from each other.

(1) A method of forming a pressure-sensitive adhesive composition layer by coating a substrate or a separator with the pressure-sensitive adhesive composition of the present invention containing a partial polymerization product of monomer components and, as required, monomer components, a polymerization initiator, a solvent, a crosslinking agent, a silane coupling agent, an oligomer, additives and so on, followed by curing (e.g. thermal curing or curing by the irradiation of active energy rays such as ultraviolet rays) the pressure-sensitive adhesive composition layer, thereby forming the pressure-sensitive adhesive layer.

(2) A method of forming a pressure-sensitive adhesive layer by coating a substrate or a separator with a pressure-sensitive adhesive composition (solution) prepared by solving, in a solvent, an acrylic polymer and, as required, monomer components, a crosslinking agent, additives, a silane coupling agent and an oligomer, followed by drying and/or curing the pressure-sensitive adhesive composition.

(3) A method of further drying the pressure-sensitive adhesive sheet manufactured by the method (1).

As the curing method adopted in the foregoing (1) to (3), preferable examples thereof include methods of curing with active energy rays (particularly, curing with UV rays), from the viewpoint of allowing attainment of excellent productivity and formation of a thick pressure-sensitive adhesive layer. Since curing by the active energy ray may be inhibited by oxygen in air, it is appropriate that the pressure-sensitive adhesive layer be shut off from the oxygen e.g. by laminating a separator on the pressure-sensitive adhesive layer or being cured in an atmosphere of nitrogen.

The method of manufacturing the pressure-sensitive adhesive sheet of the present invention by using the pressure-sensitive adhesive composition containing the acrylic polymer is not particularly limited, and is preferably e.g. the foregoing method (2). The method of manufacturing the pressure-sensitive adhesive sheet of the present invention by using the pressure-sensitive adhesive composition containing the partial polymerization product is not particularly limited, and is preferably e.g. the foregoing method (1) or (3), more preferably the foregoing method (1) in which the pressure-sensitive adhesive composition is cured by irradiation with UV rays.

In the coating process in the method of manufacturing the pressure-sensitive adhesive sheet of the present invention, conventional coating methods are applicable, and conventional coaters such as a gravure roll coater, a reverse roll coater, a kiss roll coater, a dip roll coater, a bar coater, a knife coater, a spray coater, a comma coater and a direct coater, can be used.

The thickness (total thickness) of the pressure-sensitive adhesive sheet of the present invention is not particularly limited, but is preferably from 10 μm to 1 mm, more preferably from 100 μm to 500 μm, further preferably from 150 μm to 350 μm. By adjusting the thickness to 10 μm or more, the pressure-sensitive adhesive sheet easily follows step-difference portions, and step absorbability is enhanced. The thickness of the pressure-sensitive adhesive sheet of the present invention is defined as a thickness from a point of the pressure-sensitive adhesive surface on one side of the pressure-sensitive adhesive sheet of the present invention to a point of the pressure-sensitive adhesive surface on the other side. The thickness of the pressure-sensitive adhesive sheet of the present invention does not include the thickness of the separator.

It is preferable that the pressure-sensitive adhesive sheet of the present invention has high transparency. The haze (in conformity with JIS K 7136) of the pressure-sensitive adhesive sheet of the present invention is preferably 2% or less, more preferably 1% or less. By controlling the haze to 2% or less, an optical products or optical members, which are prepared by laminating via the pressure-sensitive adhesive sheet, can have good transparency and appearance. The total light transmittance (total light transmittance in the visible light wavelength region, which is in conformity with JIS K 7361-1) is not particularly limited, but is preferably 85% or more, more preferably 90% or more. By adjusting the total light transmittance to 85% or more, an optical products or optical members, which are prepared by laminating via the pressure-sensitive adhesive sheet, can have good transparency and appearance. The haze and total light transmittance measurements can be measured by, e.g. laminating the pressure-sensitive adhesive sheet to a glass sheet or the like, and using a haze meter. Specifically, the haze and the transmittance can be determined by the method described later in the section “Evaluations” under “(2) Haze and total light transmittance”.

A 180° peeling pressure-sensitive adhesive force (1800 peeling pressure-sensitive adhesive force to glass, tensile speed: 300 mm/min, temperature: 23° C.) of the pressure-sensitive adhesive sheet of the present invention at room temperature (23° C.) is not particular limited, but is preferably 5.0 N/20 mm or more (e.g. 5.0 to 50 N/20 mm), more preferably 7.0 N/20 mm or more (e.g. 7.0 to 40 N/20 mm), further preferably 10 N/20 mm or more (e.g. 10 to 30 N/20 mm). When the pressure-sensitive adhesive sheet of the present invention is a double-sided pressure-sensitive adhesive sheet, it is preferable that the pressure-sensitive adhesive surface on at least one side thereof has the 180° peeling pressure-sensitive adhesive force at room temperature (23° C.) which falls within the range specified above, and it is more preferable that the pressure-sensitive adhesive surfaces on both sides thereof have the 180° peeling pressure-sensitive adhesive forces which fall within the range specified above. The 180° peeling pressure-sensitive adhesive force can be measured according to the method described later in the section “Evaluations” under “(6-1) 180° peeling pressure-sensitive adhesive force to glass”.

A 180° peeling pressure-sensitive adhesive force (180° peeling pressure-sensitive adhesive force to polarizing plate, tensile speed: 300 mm/min, temperature: 23° C.) of the pressure-sensitive adhesive sheet of the present invention at room temperature (23° C.) is not particular limited, but is preferably 4.0 N/20 mm or more (e.g. 4.0 to 50 N/20 mm), more preferably 6.0 N/20 mm or more (e.g. 6.0 to 40 N/20 mm), further preferably 8.0 N/20 mm or more (e.g. 8.0 to 30 N/20 mm). When the pressure-sensitive adhesive sheet of the present invention is a double-sided pressure-sensitive adhesive sheet, it is preferable that the pressure-sensitive adhesive surface on at least one side thereof has the 180° peeling pressure-sensitive adhesive force at room temperature (23° C.) which falls within the range specified above, and it is more preferable that the pressure-sensitive adhesive surfaces on both sides thereof have the 180° peeling pressure-sensitive adhesive forces which fall within the range specified above. The 180° peeling pressure-sensitive adhesive force can be measured according to the method described later in the “Evaluations” under “(6-2) 180° peeling pressure-sensitive adhesive force to polarizing plate”.

The pressure-sensitive adhesive sheet of the present invention is preferably a double-sided pressure-sensitive adhesive sheet which satisfies the following: in the following <Peel test at −30° C.> using an adherend A and an adherend B, at least one of the adherend A and the adherend B are damaged; and in the following <Peel test at −50° C.> using the adherend A and the adherend B, the adherend A and the adherend B can be peeled without damaging both of the adherend A and adhrend B. The double-sided pressure-sensitive adhesive sheet which causes breakage of at least either of adherends A and B in the following <Peel test at −30° C.>, but which can be peeled away without causing breakage of the adherends A and B in the following <Peel test at −50° C.> may be a pressure-sensitive adhesive sheet having a pressure-sensitive adhesive layer formed from the pressure-sensitive adhesive composition of the present invention, or it may be a pressure-sensitive adhesive sheet not having a pressure-sensitive adhesive layer formed from the pressure-sensitive adhesive composition of the present invention.

### <Peel Test at −30° C.>

A sample piece having a structure of adherend A/double-sided pressure-sensitive adhesive sheet/adherend B is prepared by laminating one pressure-sensitive adhesive surface of a double-sided pressure-sensitive adhesive sheet (size: 30 mm length×26 mm width) to a surface of the following adherend A and laminating the other pressure-sensitive adhesive surface to a surface of the following adherend B, Next, the sample piece is put in an autoclave, and the sample piece is treated for 15 minutes under the conditions of a pressure of 5 atm and a temperature of 50° C., followed by allowing to stand for 30 minutes at a temperature of −30° C. Then, in an environment of −30° C., the adherend A is fixed, and the adherend A and the adherend B are peeled by pulling the adherend B in a direction perpendicular to the surface of the adherend A. The pulling speed during pulling the adherend B is preferably from 10 to 1,000 mm/min, more preferably from 100 to 500 mm/min. The adherend A is a glass sheet, “Blue Plate glass (which is a general blue plate glass)” (a product of Matsunami Glass Ind., Ltd.; thickness: 0.7 mm, size: 100 mm length×50 mm width). The adherend B is a slide glass, “S1112” (trade name, a product of Matsunami Glass Ind., Ltd.; thickness: 1.0 to 1.3 mm, size: length 76 mm×width 26 mm). More specifically, the testing is carried out according to the method described later in the section “Evaluations” under “(3) Glass/glass reworkability”.

### <Peel Test at −50° C.>

A sample piece having a structure of adherend A/double-sided pressure-sensitive adhesive sheet/adherend B is prepared by laminating one pressure-sensitive adhesive surface of a double-sided pressure-sensitive adhesive sheet (size: 30 mm length×26 mm width) to a surface of the following adherend A and laminating the other pressure-sensitive adhesive surface to a surface of the following adherend B. Next, the sample piece is put in an autoclave, and the sample piece is treated for 15 minutes under the conditions of a pressure of 5 atm and a temperature of 50° C., followed by allowing to stand for 30 minutes at a temperature of −50° C. Then, in an environment of −50° C., the adherend A is fixed, and the adherend A and the adherend B are peeled by pulling the adherend B in a direction perpendicular to the surface of the adherend A. The pulling speed during pulling the adherend B is preferably from 10 to 1,000 mm/min, more preferably from 100 to 500 mm/min. The adherend A is a glass sheet, “Blue plate glass (which is a general blue plate glass)” (a product of Matsunami Glass Ind., Ltd.; thickness: 0.7 mm, size: 100 mm length×50 mm width). The adherend B is a slide glass, “S1112” (trade name, a product of Matsunami Glass Ind., Ltd.; thickness: 1.0 to 1.3 mm, size: length 76 mm×width 26 mm). More specifically, the testing is carried out according to the method described later in the “Evaluations” under “(3) Glass/glass reworkability”.

The pressure-sensitive adhesive force at −30° C. of the pressure-sensitive adhesive sheet of the present invention in the following <Film T-peel test> is not particular limited, but is preferably from 5N to 50N, more preferably from 6N to 40N, further preferably from 7N to 35N. By giving the pressure-sensitive adhesive force at −30° C. of 5N or more, the pressure-sensitive adhesive sheet is less prone to being peeled away from an adherend even at −30° C. The pressure-sensitive adhesive force at −50° C. of the pressure-sensitive adhesive sheet of the present invention in the following <Film T-peel test> is not particular limited, but is preferably from 0 to 3N, more preferably from 0 to 2.5N, further preferably from 0 to 2N, By giving the pressure-sensitive adhesive force at −50° C. of 3N or less, the adherend is peeled from the pressure-sensitive adhesive sheet at −50° C.

It is preferable that the pressure-sensitive adhesive sheet of the present invention has the pressure-sensitive adhesive force at −30° C. in a range of from 5N to 50N (preferably from 6N to 40N, more preferably from 7 to 35N) in the following <Film T-peel test>, and has the pressure-sensitive adhesive force at −50° C. in a range of from 0 to 3N (preferably from 0 to 2.5N, more preferably from 0 to 2N) in the following <Film T-peel test>. By adjusting the pressure-sensitive adhesive force as determined in the following <Film T-peel test> to fall within the forgoing ranges, the pressure-sensitive adhesive sheet has the pressure-sensitive adhesive property even at −30° C., and the pressure-sensitive adhesive force is decreased at −40° C. or less (especially −50° C. or less) to make it possible to peel the adherend away without bending the adherend even when the adherend is a warp-prone member such as a film.

### <Film T-Peel Test>

A sample piece having a structure of PET film/double-sided pressure-sensitive adhesive sheet/PET film is prepared by laminating one pressure-sensitive adhesive surface of a double-sided pressure-sensitive adhesive sheet (size: 50 mm length×20 mm width, thickness: 175 μm or 150 μm) to a surface of polyethylene tetraphthalate (PET) film (size: 150 mm length×20 mm width×100 μm thickness) and laminating the other pressure-sensitive adhesive surface to a surface of PET film (size: 150 mm length×20 mm width×100 μm thickness). Next, the sample piece is put in an autoclave, and the sample piece is treated for 15 minutes under the conditions of a pressure of 5 atm and a temperature of 50° C., followed by allowing to stand for 30 minutes at either of a temperature of −30° C. or a temperature of −50° C. Then, in the same temperature as chosen when the sample piece is stand, a T-peel test is carried out under the following conditions, and the peel strength (N) is determined. More specifically, the testing is done according to the method described later in the section “Evaluations” under “(4) Film T-peel test”.

Device: AUTOGRAPH, trade name, manufactured by Shimadzu Corporation

Sample width: 20 mm

Tensile speed: 300 mm/min

Pulling direction: CD direction (direction perpendicular to length (MD) direction)

Number of repetitions: n=3

The pressure-sensitive adhesive sheet of the present invention has excellent pressure-sensitive adhesive property at temperatures ranging from about −30° C. to room temperature (23° C.), and has reworkability at a temperature on the order of −50° C. Even in the case where adherends are laminated by the use of the pressure-sensitive adhesive sheet of the present invention, and then, the adherents are peeled again (removed), the pressure-sensitive adhesive sheet of the present invention can be suitably used as a pressure-sensitive adhesive sheet (removable pressure-sensitive adhesive sheet) having removability which allows reuse of the adherends peeled away.

The use of the pressure-sensitive adhesive sheet of the present invention is not particularly limited, and can be suitably used for optical uses, bonding uses and protection uses. In particular, the pressure-sensitive adhesive sheet of the present invention is preferably a pressure-sensitive adhesive sheet for optical uses (an optical pressure-sensitive adhesive sheet). More specifically, the pressure-sensitive adhesive sheet is a pressure-sensitive adhesive sheet used for the purpose of, e.g. laminating optical members (for lamination of optical members) or manufacturing products (optical products) using optical members.

The optical members are not particular limited so long as they have optical properties (such as a light-polarizing property, a light-refracting property, a light-scattering property, a light-reflecting property, a light-transmitting property, a light-absorbing property, a light-diffracting property, optical rotatory properties and visibility), and examples thereof include members included in optical products, such as display devices (image display devices) or input devices, or members used in these devices (optical products). More specifically, examples thereof include a polarizing plate, a wave plate, a retardation plate, an optical compensation film, a brightness-enhancing film, a light-guiding plate, a reflective film, an anti-reflective film, a transparent conductive film (such as an ITO film), a design film, a decorative film, a surface-protecting film, a prism, a lens, a color filter, a transparent substrate, and various laminates of these members.

Examples of the display devices (image display devices) include liquid-crystal display devices, organic EL (electroluminescent) display devices, PDPs (plasma display panels) and electronic papers. Examples of the input devices include touch panels.

The optical members is not particularly limited, and examples thereof include members (e.g. in a sheet form, film form or plate form) made from plastic materials, such as polyester resins such as polyethylene terephthalate (PET), acrylic resins such as polymethyl methacrylate, polycarbonate, triacetyl cellulose, polysulfone, polyarylate, polyimide, polyvinyl chloride, polyvinyl acetate, polyethylene, polypropylene and ethylene-propylene copolymer, or metal, or glass. The term “optical member” used herein is intended to include, as mentioned above, members (e.g. a design film, a decorative film, a surface protective plate or the like) which play a role of decoration or protection while keeping the visibility of adherends such as display devices or input devices.

The pressure-sensitive adhesive sheet of the present invention has the pressure-sensitive adhesive properties in a wide temperature range of −30° C. to room temperature (23° C.). In addition, the pressure-sensitive adhesive sheet can be peeled away at temperatures on the order of −50° C. or less without exerting a strong force on the member to which the pressure-sensitive adhesive sheet is laminated. Thus, even when it is a warp-prone member (e.g. a film-shaped member made from a plastic material), the member can be peeled off without bending. Thus, it is preferred that the pressure-sensitive adhesive sheet of the present invention be an optical pressure-sensitive adhesive sheet used for lamination of a plastic-based optical member provided with a break-prone film such as an ITO film (e.g. a transparent conductive film). In addition, the pressure-sensitive adhesive sheet of the present invention can be peeled away from even a member which is apt to fracture by a force applied thereto (e.g. an optical member having a high stiffness such as an optical member composed of glass) without causing fracture. Thus, it is also preferred that the pressure-sensitive adhesive sheet of the present invention be an optical pressure-sensitive adhesive sheet used for lamination of an optical member composed of glass, such as a glass sensor, a display panel made from glass (e.g. LCD) or a glass sheet with a transparent electrode in a touch panel.

The method of separating members (e.g. optical members) laminated via the pressure-sensitive adhesive sheet of the present invention is not particularly limited, and examples thereof include a method of separating members laminated via the pressure-sensitive adhesive sheet by exerting a force on at least one of the members in at least the direction of the normal to the member (e.g., a method of separation through the application of a force by inserting the tip of a tool with a cuneiform from the side of the pressure-sensitive adhesive sheet), a method of separating members laminated via the pressure-sensitive adhesive sheet by pulling them in the thickness direction (a method of separation by pulling them in the direction perpendicular to the interface between the pressure-sensitive adhesive sheet and the member), a method of separation by bringing two members laminated into relative movements in parallel with each other, and a method of making at least one of members laminated move so that mutually-parallel virtual straight lines specified in the interface between one member and the pressure-sensitive adhesive sheet and the interface between the other member and the pressure-sensitive adhesive sheet, respectively, come to have a skew positional relationship (a method of making at least one of two members move so that one pressure-sensitive adhesive surface of the pressure-sensitive adhesive sheet is skewed to the other pressure-sensitive adhesive surface of the pressure-sensitive adhesive sheet).

The expression of “bringing two members into relative movements in parallel with each other” as used above implies that at least one of two members laminated via the pressure-sensitive adhesive sheet of the present invention is moved while keeping the distance between opposed surfaces of the two members substantially constant. For instance, when the two members are flat-plate members, the expression means that at least one of two members are moved while holding the parallel relationship between the two members (flat plates).

According to the separation methods as recited above, two members laminated via the pressure-sensitive adhesive sheet of the present invention can be separated without substantially applying thereto such a force (load) as to cause damaging, cracking or distortion (deformation) in the members, even when at least one of the members is a warp-prone member or a thin member having poor flexibility.

### EXAMPLES

The present invention will now be described in further detail by reference to examples and comparative examples. However, these examples should not be construed as limiting the scope of the present invention in any way. A composition (kinds and amounts used) of monomers constituting the monomer components and a composition (kinds and amounts used) of ingredients in the pressure-sensitive adhesive composition, which are adopted in each of the following examples and comparative examples, are shown in Table 1.

### Example 1

Into a four necked flask, a mixture of 75 parts by weight of lauryl acrylate (LA), 13 parts by weight of isobornyl acrylate (IBXA), 6 parts by weight of N-vinyl-2-pyrrolidone (NVP) and 6 parts by weight of 2-hydroxyethyl acrylate (HEA), and 0.05 parts by weight of 1-hydroxycyclohexyl phenyl ketone (IRGACURE 184, trade name, a product of BASF Japan Ltd.) and 0.05 parts by weight of 2,2-dimethoxy-1,2-diphenylethane-1-one (IRGACURE 651, trade name, a product of BASF Japan Ltd.) as a photopolymerization initiator were added. The resulting mixture was irradiated with UV rays in an atmosphere of nitrogen until the viscosity thereof reached about 15 Pa's (as measured with a BH viscometer, No. 5 rotor, 10 rpm, temperature of 30° C.), thereby undergoing photo polymerization to yield a partially polymerized monomer syrup (a partial polymerization product of the monomer components).

100 parts by weight of the partially polymerized monomer syrup, 0.035 parts by weight of 1,6-hexanediol diacrylate (IDDA, polyfuntional monomer), 0.3 parts by weight of a silane coupling agent (KBM403, trade name, a product of Shin-Etsu Chemical Co., Ltd.), 0.05 parts by weight of 1-hydroxycyclohexyl phenyl ketone (IRGACURE 184, trade name, a product of BASF Japan Ltd.) as photo polymerization initiator (supplementary initiator) and 0.05 parts by weight of 2,2-dimethoxy-1,2-diphenylethane-1-one (IRGACURE 651, trade name, a product of BASF Japan Ltd.) as photo polymerization initiator (supplementary initiator) were mixed homogeneously, thereby preparing a pressure-sensitive adhesive composition.

The thus prepared pressure-sensitive adhesive composition was applied to the release-treated surface of a release film (MRF#38, trade name, a product of Mitsubishi Plastics, Inc.) so as to have a thickness of 175 μm, thereby forming a pressure-sensitive adhesive composition layer. Subsequently, the other surface of the pressure-sensitive adhesive composition layer was laminated to the release-treated surface of a release film (MRN#38, trade name, a product of Mitsubishi Plastics, Inc.), and the laminate thus formed was subjected to photo-curing through irradiation with UV rays under the conditions of an illumination of 4 mW/cm² and a light intensity of 1,200 mJ/cm², thereby forming a pressure-sensitive adhesive layer, and then, a pressure-sensitive adhesive sheet was prepared.

### Examples 2 to 7 and Comparative Examples 1 to 3

The pressure-sensitive adhesive compositions and pressure-sensitive adhesive sheets were prepared in the same manner as in Example 1, except the change of the kinds and mixing amounts of the monomer components and the kinds and mixing amounts of ingredients in the pressure-sensitive adhesive composition to those as shown in Table 1.

An oligomer A used in each of Examples 3, 5, 7 and 14 was prepared in the following manner.

Into a four necked flask, 60 parts by weight of dicyclopentanyl methacrylate (DCPMA) (methacrylic acid dicyclopentanyl ester) (FA-513M, trade name, a product of Hitachi Chemical Co., Ltd.) and 40 parts by weight of methyl methacrylate (MMA) as the monomer components, 3.5 parts by weight of α-thioglycerol as a chain transfer agent, and 100 parts by weight of ethyl acetate as a solvent for polymerization were added. In an atmosphere of nitrogen, these ingredients were stirred for one hour at 70° C., and then, 0.2 parts by weight of 2,2′-zobisisobutyronitrile as a polymerization initiator was added thereto, thereby conducting the reaction at 70° C. for 2 hours, followed by the further reaction at 80° C. for 2 hours. Then, the reaction solution was introduced into a hot atmosphere of 130° C., and the ethyl acetate, the chain transfer agent and the monomers remaining unreacted were removed therefrom by drying. Thus, an oligomer A in a solid form was obtained. The weight-average molecular weight of the oligomer A was 4,000. In addition, the glass transition temperature (Tg) of the oligomer A was 130° C.

### Example 8

Into a four necked flask, a mixture of 73 parts by weight of lauryl acrylate (LA), 21 parts by weight of N-vinyl-2-pyrrolidone (NVP) and 6 parts by weight of 2-hydroxyethyl acrylate (HEA), and 0.1 parts by weight of 1-hydroxycyclohexyl phenyl ketone (IRGACURE 184, trade name, a product of BASF Japan Ltd.) and 0.1 parts by weight of 2,2-dimethoxy-1,2-diphenylethane-1-one (IRGACURE 651, trade name, a product of BASF Japan Ltd.) were added. The resulting mixture was irradiated with UV rays in an atmosphere of nitrogen until the viscosity thereof reached about 15 Pa's (as measured with a BH viscometer, No. 5 rotor, 10 rpm, temperature of 30° C.), thereby undergoing photo polymerization to yield a partially polymerized monomer syrup (a partial polymerization product of the monomer components).

100 parts by weight of the partially polymerized monomer syrup, 0.01 parts by weight of 1,6-hexanediol diacrylate (HDDA, polyfuntional monomer), 0.5 parts by weight of dimethylaminoethyl acrylate (DMAEA, tertiary amino group-containing monomer) and 0.3 parts by weight of a silane coupling agent (KBM403, trade name, a product of Shin-Etsu Chemical Co., Ltd.) were mixed homogeneously, thereby preparing a pressure-sensitive adhesive composition.

The thus prepared pressure-sensitive adhesive composition was applied to the release-treated surface of a release film (MRF#38, trade name, a product of Mitsubishi Plastics, Inc.) so as to have a thickness of 150 μm, thereby forming a pressure-sensitive adhesive composition layer. Subsequently, the other surface of the pressure-sensitive adhesive composition layer was laminated to the release-treated surface of a release film (MRN#38, trade name, a product of Mitsubishi Plastics, Inc.), and the laminate thus formed was subjected to photo-curing through irradiation with UV rays under the conditions of an illumination of 4 mW/cm² and a light intensity of 1,200 mJ/cm², thereby forming a pressure-sensitive adhesive layer, and thus, a pressure-sensitive adhesive sheet was prepared.

### Examples 9 to 14

The pressure-sensitive adhesive compositions and pressure-sensitive adhesive sheets were prepared in the same manner as in Example 8, except the change of the kinds and mixing amounts of the monomer components and the kinds and mixing amounts of ingredients in the pressure-sensitive adhesive composition to those as shown in Table 1.

### (Evaluations)

The gel fraction, haze, total light transmittance, glass/glass reworkability, film T-peel test, melting point and 1800 peeling pressure-sensitive adhesive force were evaluated for each of the pressure-sensitive adhesive compositions and pressure-sensitive adhesive sheets obtained in Examples and Comparative Examples. The methods by which these evaluations were performed are described below. The results of these evaluations are shown in Table 1.

### (1) Gel Fraction

The measurement of the gel fraction was conducted according to the description in the above section “Method of measuring gel fraction”.

### (2) Haze and Total Light Transmittance

From each of the pressure-sensitive adhesive sheets obtained in Examples and Comparative Examples, the release film (MRN#38) on one side was peeled away, and the resulting pressure-sensitive adhesive sheet was laminated to a glass sheet (SLIDE GLASS S111, trade name, a product of Matsunami Glass Ind., Ltd.; thickness: 1.0 mm, Haze: 0.1%), and further the release film on the other side was peeled away. Thus, sample pieces were prepared.

On each of these sample pieces, the measurement of the haze (%) in conformity with JIS K 7136 and total light transmittance (%) in conformity with JIS K 7361-1 were conducted by using a haze meter (HM-150, trade name, a product of Murakami Color Research Laboratory).

### (3) Glass/Glass Reworkability

### (Preparation of Evaluative Sample)

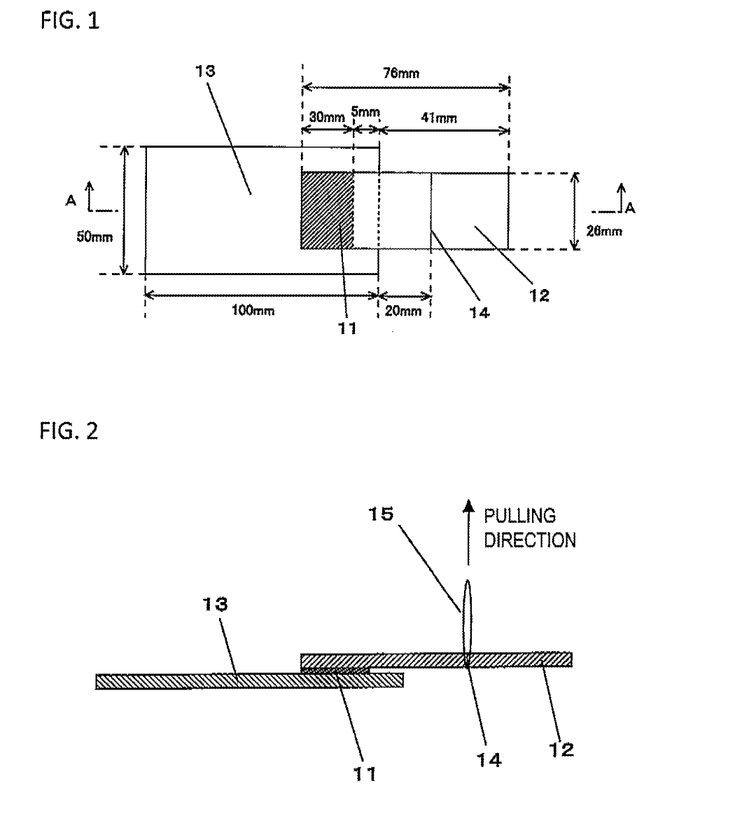

FIG. 1 is an illustration (a plan view) showing an evaluative sample used for evaluation of glass/glass reworkability. FIG. 2 is an illustration (an A-A cross-sectional view) showing the evaluative sample which is in a state of being hung with a kite string and used for evaluation of glass/glass reworkability.

A sheet piece (size: 30 mm length×26 mm width) was cut from each of the pressure-sensitive adhesive sheets obtained in Examples and Comparative Examples. The release film (MRN#38) on one side of the sheet piece was peeled away. The resulting sheet piece was laminated to a slide glass (a) 12, and the release film (MRF#38) on the other side was peeled away, and the other pressure-sensitive adhesive surface was laminated to a glass sheet (b) 13. In this way, the slide glass (a) 12 (size: 76 mm length×26 mm width, thickness: 1.0 mm) and the glass sheet (b) 13 (size: 100 mm length×50 mm width, thickness: 0.7 mm) were laminated via the sheet piece 11, thereby forming an evaluative sample as shown in FIG. 1 or FIG. 2. Thus, evaluative samples having a structure of a slide glass (a) 12/pressure-sensitive adhesive sheet 11/glass sheet (b) 13 were prepared. As shown in FIG. 1, the slide glass (a) 12 has a kite string-pulling part 14 in the width direction at a location 55 mm away from one end.

### <Peel Test at −30° C.>

Each of the evaluative samples was placed in an autoclave and the evaluative samples were treated for 15 minutes under a pressure of 5 atm and a temperature of 50° C. After the autoclave treatment, each evaluative sample was taken out of the autoclave, and allowed to stand for 30 minutes at a temperature of −30° C. Subsequently, as shown in FIG. 2, the kite string-pulling part 14 of the slide glass (a) 12 was hung with a kite string 15. Then, in the environment of −30° C., the glass sheet (b) 13 was fixed to a tensile tester by means of a metallic jig. By the use of the tensile tester, the kite string 15 was pulled in the direction (the pulling direction shown in FIG. 2) perpendicular to the surface of the glass sheet (b) 13 under the conditions of a temperature of −30° C. and a pulling speed of 300 mm/min, and thereby the slide glass (a) 12 and the glass sheet (b) 13 were separated. After the slide glass (a) 12 and the glass sheet (b) 13 were separated, conditions thereof were visually observed, and evaluated on the basis of the following criteria.

The glass/glass reworkability (−30° C.) was rated as “good (A)” when both the slide glass (a) and the glass (b) were separated without breaking, and it was rated as “poor (B)” when at least one of the slide glass (a) and the glass (b) were damaged.

### <Peel Test at −50° C.>

Each of the evaluative samples was placed in an autoclave and the evaluative samples were treated for 15 minutes under a pressure of 5 atm and a temperature of 50° C. After the autoclave treatment, each evaluative sample was taken out of the autoclave, and allowed to stand for 30 minutes at a temperature of −50° C. Subsequently, as shown in FIG. 2, the kite string-pulling part 14 of the slide glass (a) 12 was hung with a kite string 15. Then, in the environment of −50° C., the glass sheet (b) 13 was fixed to a tensile tester by means of a metallic jig. By the use of the tensile tester, the kite string 15 was pulled in the direction (the pulling direction shown in FIG. 2) perpendicular to the surface of the glass sheet (b) 13 under the conditions of a temperature of −50° C. and a pulling speed of 300 mm/min, and thereby the slide glass (a) 12 and the glass sheet (b) 13 were separated. After the slide glass (a) 12 and the glass sheet (b) 13 were separated, conditions thereof were visually observed, and evaluated on the basis of the following criteria.

The glass/glass reworkability (−50° C.) was rated as “good (A)” when both the slide glass (a) and the glass (b) were separated without breaking, and it was rated as “poor (B)” when at least one of the slide glass (a) and the glass (b) were damaged.

### (4) Film T-Peel Test

### (Preparation of Evaluative Sample)

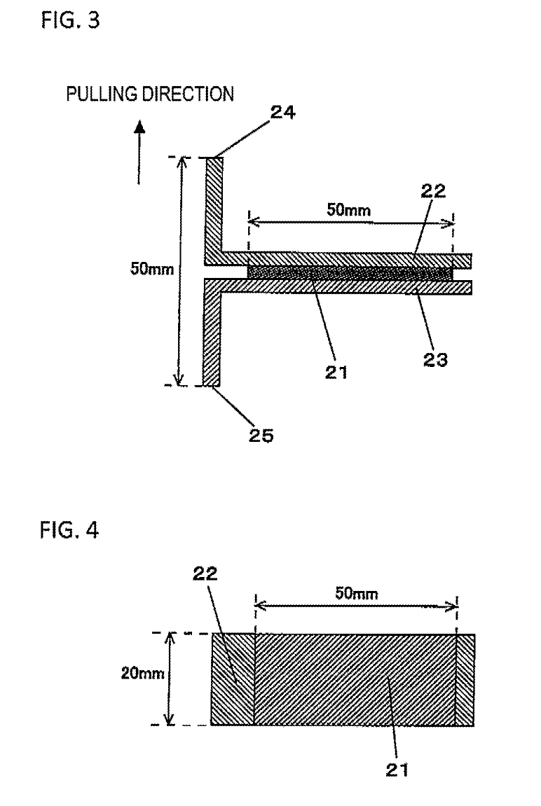

FIG. 3 is an illustration (a cross-sectional view) showing each of the evaluative samples used in film T-peel tests. FIG. 4 is an illustration (a plan view) showing each of evaluative samples used for film T-peel tests in Examples.

Sheet pieces (size: 50 mm length×20 mm width, thickness: 175 μm or 150 μm) were out from each of the pressure-sensitive adhesive sheets obtained in Examples and Comparative Examples. The release film (MRN#38) on one side of each sheet piece was peeled away. The resulting sheet piece was laminated to a polyethylene terephthalate film (PET film) (i) 22 (A4100, trade name, a product of TOYOBO CO., LTD., size: 150 mm length×20 mm width, thickness: 100 μm), and the release film (MRF#38) on the other side was peeled away, and the other pressure-sensitive adhesive surface was laminated to a PET film (ii) 23 (A4100, trade name, a product of TOYOBO CO., LTD., size: 150 mm length×20 mm width, thickness: 100 μm), and thus, the PET film (i) 22 and the PET film (ii) 23 were laminated via the sheet piece 21 thereby to form an evaluative sample (FIGS. 3 and 4). In this way, evaluative samples having a structure of PET film (i) 22/pressure-sensitive adhesive sheet (sheet piece) 21/PET film (ii) 23 were prepared.

### <Film T-Peel Test>

Each of the evaluative samples was placed in an autoclave and the evaluative samples were treated for 15 minutes under a pressure of 5 atm and a temperature of 50° C. After the autoclave treatment, each evaluative sample was taken out of the autoclave, and the sheet pieces thereof were allowed to stand for 30 minutes under the environments of a temperature of −30° C. or −50° C. Thereafter, in the environment same as the environment where the sheet piece was left standing, one end 24 of the PET film (i) and one end 25 of the PET film (ii) were fixed to a tensile tester by means of chucks (gripping tools), and the end 24 of the PET film (i) was pulled in the pulling direction shown in FIG. 3 (in the direction shown by the arrow in FIG. 3), and thus, the PET film (i) 22 and the PET film (ii) 23 were separated. The maximum load required for separating them was measured. Such a test was performed three times (n=3), and the mean of the measurement values was defined as a film T-peel force (N).

Device (Tensile tester): AUTOGRAPH, trade name, a product of Shimadzu Corporation

Sample width: 20 mm

Pulling speed: 300 mm/min

Pulling direction: CD direction (the direction shown by the arrow in FIG. 3, namely the direction perpendicular to the contact interface between the sheet piece 21 and the PET film (i) 22 and between the sheet piece 21 and the PET film (ii) 23)

Number of repetitions: n=3

The separability was rated as A (excellent, or equivalently, poor in pressure-sensitive adhesive property) when the film T-peel force measured was less than 2N, it was rated as B (somewhat poor, or equivalently, good in pressure-sensitive adhesive property) when the film T-peel force measured was 2N or more and less than 5N, and it was rated as C (poor, or equivalently, excellent in pressure-sensitive adhesive property) when the film T-peel force measured was 5N or more.

The evaluation results of the film T-peel force in the film T-peel test at −30° C. and the separability are shown in the columns “Film T-peel force (N) (−30° C.)” and “Separability evaluation (−30° C.)” of Table 1, respectively. The evaluation results of the film T-peel force in the film T-peel test at −50° C. and the separability are shown in the columns “Film T-peel force (N) (−50° C.)” and “Separability evaluation (−50° C.)” of Table 1, respectively.

### (5) Melting Point

A sample for measurement was prepared by taking 2 to 3 mg of pressure-sensitive adhesive layer out of each of the pressure-sensitive adhesive sheets obtained in Examples and Comparative Examples, putting the taken pressure-sensitive adhesive layer in an aluminum container and crimping the container. The sample for measurement was subjected to the measurement using a differential scanning calorimeter (DSC) (Q-2000, trade name, a product of TA Instruments, Inc.) in conformity with JIS K 7121 under the condition of a rate of temperature rise of 10° C./min in the temperature range of from −80° C. to 80° C. And the temperature (Tm) of the heat-absorption peak top in this measurement was defined as a melting point (° C.).

When a sample was not crystallized, the melting point of the sample was not able to be measured. The melting point in this case is symbolized by “x”.

In addition, the case where no measurement for the melting point was made is symbolized by “−”.

### (6-1) 180° Peeling Pressure-Sensitive Adhesive Force to Glass

A sheet piece having a length of 100 mm and width of 20 mm (a sheet piece having a size of 100 mm×20 mm) was cut from each of the pressure-sensitive adhesive sheets obtained in Examples and Comparative Examples. The release film (MRN#38) on one side of the sheet piece was peeled away, and the thus bared pressure-sensitive adhesive surface (surface opposite to the surface to be measured) of the sheet piece was laminated to (lined with) a PET film (LUMIRROR S-10, trade name, a product of TORAY INDUSTRIES, INC., thickness: 50 μm), thereby making a sheet piece in rectangular form.

Subsequently, the release film (MRF#38) on the other side was peeled away from the sheet piece in rectangular form, and the thus bared pressure-sensitive adhesive surface (the surface to be measured) was pressed on a glass sheet (manufactured by Matsunami Glass Ind., Ltd.; thickness: 0.7 mm) by moving a 2 kg roller forward and backward once in the atmosphere of 23° C., thereby making a sample for measurement.

The sample for measurement was allowed to stand for 30 minutes in the atmosphere of 23° C. and 50% RH, and after that, a 180° peel test was carried out using a tensile tester, and then 180° peeling pressure-sensitive adhesive force (N/20 mm) to the glass sheet was measured. This measurement was carried out in the atmosphere of 23° C. and 50% RH under the conditions of a peel angle of 180° and a tensile speed of 300 mm/min.

### (6-2) 180° Peeling Pressure-Sensitive Adhesive Force to Polarizing Plate

A sheet piece having a length of 100 mm and a width of 20 mm (a sheet piece having a size of 100 mm×20 mm) was cut from each of the pressure-sensitive adhesive sheets obtained in Examples and Comparative Examples. The release film (MRN#38) on one side of the sheet piece was peeled away, and the thus bared pressure-sensitive adhesive surface (surface opposite to the surface to be measured) of the sheet piece was laminated to (lined with) a PET film (LUMIRROR S-10, trade name, a product of TORAY INDUSTRIES, INC., thickness: 50 μm), thereby making a sheet piece in rectangular form.

Subsequently, the release film (MRF#38) on the other side was peeled away from the sheet piece in rectangular form, and the thus bared pressure-sensitive adhesive surface (the surface to be measured) was pressed on a polarizing plate (manufactured by NITTO DENKO CORPORATION; thickness: 250 μm) by moving a 2 kg roller forward and backward once in the atmosphere of 23° C., thereby making a sample for measurement.

The sample for measurement was allowed to stand for 30 minutes in the atmosphere of 23° C. and 50% RH, and after that, a 180° peel test was carried out using a tensile tester, and the 1800 peeling pressure-sensitive adhesive force (N/20 mm) to the polarizing plate was measured. This measurement was carried out in the atmosphere of 23° C. and 50% RH under the conditions of a peel angle of 180° and a tensile speed of 300 mm/min.

When such measurement was not made, the mark “−” is shown in the column “1800 peeling pressure-sensitive adhesive force to polarizing plate (N/20 mm)”.

### (7) White-Turbidity Resistance Under Humidified Condition

A sheet piece having a length of 100 mm and a width of 50 mm (a sheet piece having a size of 100 mm×50 mm) was cut from each of the pressure-sensitive adhesive sheets obtained in Examples and Comparative Examples. The release film (MRN#38) on one side of the sheet piece was peeled away, and the thus bared pressure-sensitive adhesive surface of the sheet piece was laminated to a glass sheet (a product of Matsunami Glass Ind., Ltd.; thickness: 0.7 mm, size: 100 mm length×50 mm width) by means of a hand roller. The release film (MRF#38) on the other side was peeled away, and the thus bared pressure-sensitive adhesive surface was also laminated to a glass sheet (a product of Matsunarnmi Glass Ind., Ltd.; thickness: 0.7 mm, size: 100 mm length×50 mm width) in the same manner, thereby laminating the two glass sheets via the sheet piece. Thus, evaluative samples having a structure of glass sheet/pressure-sensitive adhesive sheet (sheet piece)/glass sheet were obtained.

Each of the evaluative samples was placed in an autoclave, followed by subjecting to autoclave treatment for 15 minutes under a pressure of 5 atm and a temperature of 50° C. After the autoclave treatment, each evaluative sample was taken out of the autoclave, followed by allowing to stand for 100 hours in humidified environments (temperature: 85° C., humidity: 85% RH). Then, each evaluative sample was allowed to stand for 24 hours in room temperature environments (temperature: 23° C., humidity: 50% RH). Thereafter, whether or not white turbidity developed in the pressure-sensitive adhesive layer of each evaluative sample was visually observed, and evaluated on the basis of the following criteria.

In white turbidity resistance under humidified conditions, the case where no white turbidity was observed is rated as A (excellent), the case where white turbidity was observed in the pressure-sensitive adhesive only at the four corners of the evaluative sample was rated as B (good), the case where white turbidity observed in the pressure-sensitive adhesive only in the periphery of the evaluative sample was rated as C (somewhat poor), and the case where white turbidity was observed over the whole pressure-sensitive adhesive in the evaluative sample was rated as D (poor).

TABLE 1

| | | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|
| Monomer | C₁₀₋₁₃ Alkyl (meth)acrylate | LA | 75 | 73 | 71.6 | 73 | 73 | 73 | 73 | 73 | 73 |
| components of | (parts by weight) | | | | | | | | | | |
| partial | Alicyclic monomer | IBXA | 13 | 15 | 14.7 | 5 | 5 | | | | |
| polymerization | (parts by weight) | | | | | | | | | | |
| product | Polar group-containing | NVP | 6 | 6 | 5.9 | 16 | 16 | 21 | 21 | 21 | 21 |
| | monomer | HEA | 6 | 6 | 5.9 | 6 | 6 | 6 | 6 | 6 | 6 |
| | (parts by weight) | DMAEA | | | | | | | | | |
| | | DMAPAA | | | | | | | | | |
| | C₁₋₉ Alkyl (meth)acrylate | 2EHA | | | | | | | | | |
| | (parts by weight) | | | | | | | | | | |
| | Carboxyl group-containing | AA | | | | | | | | | |
| | monomer | | | | | | | | | | |
| | (parts by weight) | | | | | | | | | | |
| Pressure- | Partial polymerization | | 100 | 100 | 100 | 100 | 100 | 100 | 100 | 100 | 100 |
| sensitive | product | | | | | | | | | | |
| adhesive | (parts by weight) | | | | | | | | | | |
| composition | Polyfunctional monomer | HDDA | 0.035 | 0.035 | 0.04 | 0.015 | 0.03 | 0.01 | 0.015 | 0.01 | 0.01 |
| | (parts by weight) | DPHA | | | | | | | | | |
| | Polar group-containing | DMAEA | | | | | | | | 0.5 | 3 |
| | monomer | DMAPAA | | | | | | | | | |
| | (parts by weight) | | | | | | | | | | |
| | Silane coupling agent | KBM403 | 0.3 | 0.3 | 0.3 | 0.3 | 0.3 | 0.3 | 0.3 | 0.3 | 0.3 |
| | (parts by weight) | | | | | | | | | | |
| | Oligomer (parts by weight) | Oligomer A | | | 2 | | 5 | | 2 | | |

| Gel fraction (%) | | 71.1 | 69.9 | 65.6 | 72.4 | 47.0 | 70.9 | 60.0 | 64.0 | 56.0 |
|---|---|---|---|---|---|---|---|---|---|---|
| Haze (%) | | 0.4 | 0.4 | 0.4 | 0.5 | 0.5 | 0.5 | 0.4 | 0.5 | 0.5 |
| Total light transmittance (%) | | 91.8 | 91.8 | 91.7 | 92.2 | 91.4 | 92.2 | 92.2 | 92.2 | 92.2 |
| Glass/glass reworkability (−30° C.) | | B | B | B | B | B | B | B | B | B |
| Glass/glass reworkability (−50° C.) | | A | A | A | A | A | A | A | A | A |
| Film T- | Film T-peel force (N) (−30° C.) | 32.8 | 23.5 | 20.0 | 5.1 | 13.9 | 17.2 | 7.2 | 11.0 | 3.7 |
| peel test | Separability evaluation (−30° C.) | C | C | C | C | C | C | C | C | B |
| | Film T-peel force (N) (−50° C.) | 1.2 | 1.1 | 1.1 | 0.8 | 0.8 | 1.4 | 1.3 | 0.5 | 1.1 |
| | Separability evaluation (−50° C.) | A | A | A | A | A | A | A | A | A |

| | | | | | | | | | |
|---|---|---|---|---|---|---|---|---|---|
| 180° peeling pressure-sensitive adhesive force to glass | 13.6 | 15.1 | 18.4 | 15.2 | 17.4 | 15.7 | 16.0 | 16.4 | 24.6 |
| (N/20 mm) | | | | | | | | | |
| 180° peeling pressure-sensitive adhesive force to polarizing | — | 10.0 | — | 9.1 | 7.5 | 9.8 | 10.0 | 17.1 | 18.3 |
| plate (N/20 mm) | | | | | | | | | |
| Melting point (° C.) | −15 | −20 | −21 | −13 | −13 | −10 | −10 | — | −14 |
| White turbidity resistance under humidified condition | B | B | A | A | A | A | A | A | B |

| | | | | | | | | Comp. | Comp. | Comp. |
|---|---|---|---|---|---|---|---|---|---|---|
| | | | Ex. 10 | Ex. 11 | Ex. 12 | Ex. 13 | Ex. 14 | Ex. 1 | Ex. 2 | Ex. 3 |
| Monomer | C₁₀₋₁₃ Alkyl (meth)acrylate | LA | 70.9 | 73 | 73 | 70.9 | 73 | 66 | | 84 |
| components of | (parts by weight) | | | | | | | | | |
| partial | Alicyclic monomer | IBXA | | | | | | | | 10 |
| polymerization | (parts by weight) | | | | | | | | | |
| product | Polar group-containing | NVP | 20.4 | 21 | 21 | 20.4 | 21 | 6 | | 6 |
| | monomer | HEA | 5.8 | 6 | 6 | 5.8 | 6 | 6 | | |
| | (parts by weight) | DMAEA | 2.9 | | | | | | | |
| | | DMAPAA | | | | 2.9 | | | | |
| | C₁₋₉ Alkyl (meth)acrylate | 2EHA | | | | | | 22 | 90 | |
| | (parts by weight) | | | | | | | | | |
| | Carboxyl group containing- | AA | | | | | | | 10 | |
| | monomer | | | | | | | | | |
| | (parts by weight) | | | | | | | | | |
| Pressure- | Partial polymerization | | 100 | 100 | 100 | 100 | 100 | 100 | 100 | 100 |
| sensitive | product | | | | | | | | | |
| adhesive | (parts by weight) | | | | | | | | | |
| composition | Polyfunctional monomer | HDDA | 0.05 | 0.01 | 0.005 | 0.005 | 0.04 | 0.03 | | 0.04 |
| | (parts by weight) | DPHA | | | | | | | 0.07 | |
| | Polar group-containing monomer | DMAEA | | | | | 3 | | | |
| | (parts by weight) | DMAPAA | | 0.5 | 3 | | | | | |
| | Silane coupling agent | KBM403 | 0.3 | 0.3 | 0.3 | 0.3 | | 0.3 | 0.3 | 0.3 |
| | (parts by weight) | | | | | | | | | |
| | Oligomer (parts by weight) | Oligomer A | | | | | 2 | | | |

| Gel fraction (%) | | 71.9 | 69.0 | 78.0 | 67.7 | 70.0 | 61.6 | 65.0 | 67.8 |
|---|---|---|---|---|---|---|---|---|---|
| Haze (%) | | 0.7 | 0.7 | 1.2 | 1.0 | 0.5 | 0.3 | 0.3 | 0.3 |
| Total light transmittance (%) | | 92.1 | 92.1 | 92.1 | 92.0 | 92.0 | 91.8 | 92.5 | 92.5 |
| Glass/glass reworkability (−30° C.) | | B | B | B | B | B | B | B | A |
| Glass/glass reworkability (−50° C.) | | A | A | A | A | A | B | B | A |
| Film T- | Film T-peel force (N) (−30° C.) | 11.0 | 8.4 | 2.9 | 5.5 | 5.6 | 30.0 | 2.4 | 1.90 |
| peel test | Separability evaluation (−30° C.) | C | C | B | C | C | C | B | A |
| | Film T-peel force (N) (−50° C.) | 1.4 | 0.6 | 1.1 | 0.5 | 0.5 | 9.4 | 2.2 | 1.1 |
| | Separability evaluation (−50° C.) | A | A | A | A | A | C | B | A |

| | | | | | | | | |
|---|---|---|---|---|---|---|---|---|
| 180° peeling pressure-sensitive adhesive force to glass | 14.4 | 16.2 | 14.2 | 12.4 | 16.0 | 10.7 | 24.8 | 7.5 |
| (N/20 mm) | | | | | | | | |
| 180° peeling pressure-sensitive adhesive force to polarizing | 13.2 | 14.6 | 19.2 | 14.4 | 15.8 | — | 7.1 | — |
| plate (N/20 mm) | | | | | | | | |
| Melting point (° C.) | — | — | −10 | — | — | −21 | x | −10 |
| White turbidity resistance under humidified condition | A | A | A | A | A | B | B | C |

The abbreviations used for the monomer components in Table 1 are as follows.
LA: Lauryl acrylate
IBXA: Isobornyl acrylate
NVP: N-Vinyl-2-pyrrolidone
HEA: 2-Hydroxyethyl acrylate
DMAEA: Dimethylaminoethyl acrylate
DMAPAA: Dimethylaminopropyl acrylamide
2EHA: 2-Ethylhexyl acrylate
AA: Acrylic acid
HDDA: 1,6-Hexanediol diacrylate
DPHA: Dipenthaerythritol hexaacrylate

As can be clearly seen from the results shown in Table 1, the pressure-sensitive adhesive sheets prepared in Examples 1 to 14 had excellent pressure-sensitive adhesive properties at room temperature, and bad excellent pressure-sensitive adhesive properties at −30° C. In addition, they had excellent reworkability at −50° C. Further, the pressure-sensitive adhesive sheets prepared in Examples 4 to 7 were especially superior in white-turbidity resistance under humidified conditions. Furthermore, the pressure-sensitive adhesive sheets prepared in Examples 8 to 14 were especially superior in pressure-sensitive adhesive force to polarizing plates.

The present invention provides the following pressure-sensitive adhesive composition, pressure-sensitive adhesive sheet, and double-sided pressure-sensitive adhesive sheet.

(1) A pressure-sensitive adhesive composition, comprising an acrylic polymer produced by polymerizing a monomer component or a partial polymerization product of the monomer component, wherein

the monomer component includes alkyl (meth)acrylate having an alkyl group having 10 to 13 carbon atoms and a polar group-containing monomer other than a carboxyl group-containing monomer,

a content of the alkyl (meth)acrylate is 40 wt % or more and less than 80 wt % with respect to a total amount (100 wt %) of the monomer component,

a content of the polar group-containing monomer is 7 wt % or more with respect to the total amount (100 wt %) of the monomer component, and

a total content of the polar group-containing monomer and an alicyclic monomer is 15 wt % or more with respect to the total amount (100 wt %) of the monomer component.

(2) The pressure-sensitive adhesive composition according to (1), wherein the polar group-containing monomer is at least one monomer selected from the group consisting of a hydroxyl group-containing monomer and a nitrogen atom-containing monomer.

(3) A pressure-sensitive adhesive sheet, comprising a pressure-sensitive adhesive layer formed from the pressure-sensitive adhesive composition according to (1) or (2).

(4) The pressure-sensitive adhesive sheet according to (3), wherein a content of the acrylic polymer in the pressure-sensitive adhesive layer is 50 wt % or more.

(5) The pressure-sensitive adhesive sheet according to (3) or (4), which is a pressure-sensitive adhesive sheet for an optical use.

(6) A double-sided pressure-sensitive adhesive sheet, wherein, in the following peel test at −30° C. using an adherend A and an adherend B, at least one of the adherend A and the adherend B is damaged; and in the following peel test at −50° C. using the adherend A and the adherend B, the adherends A and the adherend B are peeled without damaging both of the adherend A and the adherend B,

peel test at −30° C.: a test piece having a structure of adherend A/double-sided pressure-sensitive adhesive sheet/adherend B is prepared by laminating a surface of the following adherend A to one pressure-sensitive adhesive surface of a double-sided pressure-sensitive adhesive sheet having a size of 30 mm length×26 mm width, and laminating a surface of the following adherend B to the other pressure-sensitive adhesive surface of the double-sided pressure-sensitive adhesive sheet; the test piece is treated for 15 minutes under the conditions of a pressure of 5 atm and a temperature of 50° C., and then, the test piece is allowed to stand for 30 minutes under an environment of −30° C., followed by fixing the adherend A under the environment of −30° C.; and the adherend A and the adherend B are peeled by pulling the adherend B in a direction perpendicular to the surface of the adherend A;

peel test at −50° C.: a test piece having a structure of adherend A/double-sided pressure-sensitive adhesive sheet/adherend B is prepared by laminating a surface of the following adherend A to one pressure-sensitive adhesive surface of a double-sided pressure-sensitive adhesive sheet having a size of 30 mm length×26 mm width, and laminating a surface of the following adherend B to the other pressure-sensitive adhesive surface of the double-sided pressure-sensitive adhesive sheet; the test piece is treated for 15 minutes under the conditions of a pressure of 5 atm and a temperature of 50° C., and then, the test piece is allowed to stand for 30 minutes under an environment of −50° C., followed by fixing the adherend A under the environment of −50° C.; and the adherend A and the adherend B are peeled by pulling the adherend B in a direction perpendicular to the surface of the adherend A;

adherend A: a glass sheet having a thickness of 0.7 mm and a size of 100 mm length×50 mm width; and

adherend B: a slide glass having a thickness of 1.0 mm to 1.3 mm and a size of 76 mm length×26 mm width.

While the invention has been described in detail and with reference to specific embodiments thereof, it will be apparent to one skilled in the art that various changes and modifications can be made therein without departing from the spirit and scope thereof.

This application is based on Japanese Patent Application No. 2012-103117 filed on Apr. 27, 2012, Japanese Patent Application No. 2012-126915 filed on Jun. 4, 2012 and Japanese Patent Application No. 2012-257276 filed on Nov. 26, 2012, the entire subject matters of which are incorporated herein by reference.

### DESCRIPTION OF REFERENCE NUMERALS AND SIGNS

11 Sheet piece (pressure-sensitive adhesive sheet)
12 Slide glass (a)
13 Glass sheet (b)
14 Kite string-pulling part
15 Kite String
21 Sheet piece (pressure-sensitive adhesive sheet)
22 Polyethylene terephthalate film (i) (PET film (i))
23 Polyethylene terephthalate film (ii) (PET film (ii))
24 End of polyethylene terephthalate film (i) (end of PET film (i))
25 End of polyethylene terephthalate film (ii) (end of PET film (ii))

What is claimed is:

1. A pressure-sensitive adhesive composition, comprising an acrylic polymer produced by polymerizing a monomer component or a partial polymerization product of the monomer component, wherein
the monomer component includes alkyl (meth)acrylate having an alkyl group having 10 to 13 carbon atoms and a polar group-containing monomer other than a carboxyl group-containing monomer,
a content of the alkyl (meth)acrylate is 40 wt % or more and less than 80 wt % with respect to a total amount (100 wt %) of the monomer component,
a content of the polar group-containing monomer is 7 wt % or more with respect to the total amount (100 wt %) of the monomer component, and
a total content of the polar group-containing monomer and an alicyclic monomer is 15 wt % or more with respect to the total amount (100 wt %) of the monomer component.

2. The pressure-sensitive adhesive composition according to claim 1, wherein the polar group-containing monomer is at least one monomer selected from the group consisting of a hydroxyl group-containing monomer and a nitrogen atom-containing monomer.

3. A pressure-sensitive adhesive sheet, comprising a pressure-sensitive adhesive layer formed from the pressure-sensitive adhesive composition according to claim 1.

4. A pressure-sensitive adhesive sheet, comprising a pressure-sensitive adhesive layer formed from the pressure-sensitive adhesive composition according to claim 2.

5. The pressure-sensitive adhesive sheet according to claim 3, wherein a content of the acrylic polymer in the pressure-sensitive adhesive layer is 50 wt % or more.

6. The pressure-sensitive adhesive sheet according to claim 4, wherein a content of the acrylic polymer in the pressure-sensitive adhesive layer is 50 wt % or more.

7. The pressure-sensitive adhesive sheet according to claim 3, which is a pressure-sensitive adhesive sheet for an optical use.

8. The pressure-sensitive adhesive sheet according to claim 4, which is a pressure-sensitive adhesive sheet for an optical use.

9. The pressure-sensitive adhesive sheet according to claim 5, which is a pressure-sensitive adhesive sheet for an optical use.

10. The pressure-sensitive adhesive sheet according to claim 6, which is a pressure-sensitive adhesive sheet for an optical use.

11. A double-sided pressure-sensitive adhesive sheet, wherein, in the following peel test at −30° C. using an adherend A and an adherend B, at least one of the adherend A and the adherend B is damaged; and in the following peel test at −50° C. using the adherend A and the adherend B, the adherends A and the adherend B are peeled without damaging both of the adherend A and the adherend B,
peel test at −30° C.: a test piece having a structure of adherend A/double-sided pressure-sensitive adhesive sheet/adherend B is prepared by laminating a surface of the following adherend A to one pressure-sensitive adhesive surface of a double-sided pressure-sensitive adhesive sheet having a size of 30 mm length×26 mm width, and laminating a surface of the following adherend B to the other pressure-sensitive adhesive surface of the double-sided pressure-sensitive adhesive sheet; the test piece is treated for 15 minutes under the conditions of a pressure of 5 atm and a temperature of 50° C., and then, the test piece is allowed to stand for 30 minutes under an environment of −30° C., followed by fixing the adherend A under the environment of −30° C.; and the adherend A and the adherend B are peeled by pulling the adherend B in a direction perpendicular to the surface of the adherend A;
peel test at −50° C.: a test piece having a structure of adherend A/double-sided pressure-sensitive adhesive sheet/adherend B is prepared by laminating a surface of the following adherend A to one pressure-sensitive adhesive surface of a double-sided pressure-sensitive adhesive sheet having a size of 30 mm length×26 mm width, and laminating a surface of the following adherend B to the other pressure-sensitive adhesive surface of the double-sided pressure-sensitive adhesive sheet; the test piece is treated for 15 minutes under the conditions of a pressure of 5 atm and a temperature of 50° C., and then, the test piece is allowed to stand for 30 minutes under an environment of −50° C., followed by fixing the adherend A under the environment of −50° C.; and the adherend A and the adherend B are peeled by pulling the adherend B in a direction perpendicular to the surface of the adherend A;
adherend A: a glass sheet having a thickness of 0.7 mm and a size of 100 mm length×50 mm width; and
adherend B: a slide glass having a thickness of 1.0 mm to 1.3 mm and a size of 76 mm length×26 mm width.
